(19) United States
(12) Patent Application Publication
(10) Pub. No.: US 2007/0080623 A1
(43) Pub. Date: Apr. 12, 2007

(54) Stress luminescent device using stress luminescent material

(76) Inventor: Keiji Iimura, Tokyo (JP)

Correspondence Address: KEIJI IIMURA, 10-8, AKATSUKA 3 CHOME, ITABASHI-KU, TOKYO, 175-0092, JP

(21) Appl. No.: 11/595,914

(22) Filed: Nov. 13, 2006

(30) Foreign Application Priority Data
May 6, 2004 (JP) 2004-137008

(51) Int. Cl. H01J 1/62

(52) U.S. Cl. 313/483

(57) ABSTRACT

The disclosed light emitting device (10) is a stress luminescent device which emits light, without fuel and chemical light emitting material. The stress luminescent device (10) may be composed of a container (20) e.g. capsule having a space (40) therein, at least one member (30) e.g. a particle movably accommodated in the space (40) and a stress luminescent material contained in/on the member (30) or in/on the container (20). The stress luminescent material emits light when a mechanical force is added thereto or to the stress luminescent device (10) by a manual power or a vibrator. If the mechanical force is given to the stress luminescent device (10) by a manual handling such as shaking, rotating, swinging and/or striking, any other energies including an electric power is not required.

### CROSS-REFERENCE TO RELATED APPLICATIONS

The present application is based on the prior foreign application, Japanese Patent Application No. 2004-137008, filed on May 6, 2004 which is published as Japanese Patent Application publication No. P2005-322421A published on Nov. 17, 2005 and the entire disclosure of which is incorporated by reference herein in its entirety.

### BACKGROUND OF THE INVENTION

1. Field of the Invention

This invention relates to a light emitting device which do not necessarily need an electric power source such as a dc-battery and a commercial electric power supply and also do not need fuel.

This invention also relates to the light sources used mainly in indoor, a dark place and nighttime, such as an emergency light which can be used for an electric power failure, a traffic accident, disaster and an accident, a demonstration light which can be used for an exhibition or advertisement and a luminescent toy.

2. Description of Related Art

As well known, stick-like or rod-like chemical luminescent i.e. chemiluminescent lights are widely used in the emergency lights, the demonstration light and the luminescent toys which do not need an electric power source or fuel, in which the chemiluminescent use a chemical luminescent phenomenon.

The stick-like or rod-like chemiluminescent light is disclosed for example in U.S. Patent document No. U.S. Pat. No. 3,576,987, in which the chemiluminescent light is composed of an outer flexible, cylindrical, light transmitting tubular container for one reactive liquid composition and an inner, rigid tubular container made of glass for another reactive liquid composition, when the outer container is bent, the inner container is broken for allowing the both reactive liquid compositions to mix and produce a reaction providing chemiluminescent light which is visible through the outer light transmitting container.

As well known, a stress luminescent material shows a stress luminescent characteristic which emits light reversibly when a mechanical stimulus, mechanical stress or mechanical energy is applied to the stress luminescent material, in which the mechanical stimulus, mechanical stress or mechanical energy includes friction, impact, compression, bending and tension.

The term Stress Luminescent is also called as Triboluminescent and Mechanical Luminescent (or Mechano-luminescent).

The term Stress Luminescence is also called as Triboluminescence, Mechanical Luminescence and Mechano-luminescence.

This stress luminescent material is disclosed for example in some patent documents as mentioned below.

Japanese patent application publication JP 45-11194 discloses a luminescent device including a metal chelate which is a kind of stress luminescent material to emit light when a mechanical energy such as vibration, an impact, a supersonic wave and a mechanical compression is applied.

Japanese patent application publication JP48-46582 discloses a triboluminescent element composed of a base plate and a phosphor of aluminate strontium with europium as additive coated on the base plate, in which the triboluminescent element emits visible light with yellow green color that can be seen by human eyes under a room with normal brightness when a mechanical energy such as friction and impact is applied thereto.

Further, JP48-46582 discloses that the triboluminescent element has a long lasting or light storage nature in such a manner that the light continues to emit about 30 to 60 minutes after the mechanical energy is removed.

Japanese patent application publication JP 56-136874A discloses a triboluminescent material which is composed of a picoline acid chloride containing the crystalline rare earth element of a europium or a terbium, in which the picoline acid chloride with the europium emits red light and the picoline acid chloride with the terbium emits green light when a mechanical energy is applied to the triboluminescent material.

U.S. patent document U.S. Pat. No. 6,281,617 and the corresponding Japanese patent application publication JP2000-173301A disclose a piezoelectric luminous element display device or element utilizing a triboluminescence phenomenon, which is composed of a pressure luminous layer emitting light upon the application of pressure and a piezoelectric element having a piezoelectric film held between electrode films located so as to be capable of applying pressure on the pressure luminous layer.

U.S. patent document U.S. Pat. No. 6,280,655 and the corresponding Japanese patent application publication JP2001-049251A disclose a high-luminosity stress-luminescent material such as compression, shearing and rubbing, which is composed of an alkaline earth aluminate of a non-stoichiometric composition deficient in the content of the alkaline earth element by 0.01 to 20% by moles from stoichiometry.

U.S. patent document U.S. Pat. No. 6,117,574 and the corresponding Japanese patent application publication JP H11-116946A disclose an inorganic triboluminescent material in the form of a powder, sintered block or thin film, of which the matrix phase is a piezoelectric crystalline material of a wurtzite structure such as zinc sulfide and the activator to serve as the center of luminescence is a transition metal element such as manganese, copper and rare earth elements.

U.S. patent document U.S. Pat. No. 6,710,328 discloses a fiber optic composite damage sensor for detecting damage in an object, which is composed of a triboluminescent means and a triboluminescent means each being adaptable to association with the object so that a mechanical event attendant the damage is capable of causing the triboluminescent means to emit light at least some of which is transmissible by the fiber optic means.

The fiber optic means includes outer casing means and inner transmissive means; at least a portion of the outer casing means is capable of allowing at least some the emitted light to pass therethrough so as to reach the inner transmissive means; and the inner transmissive means is capable of transmitting at least some the emitted light which has passed through the outer casing means.

U.S. patent application publication US20030124383 and the corresponding Japanese application publication 2003-165973 disclose a mechanoluminescence material produced by adding a luminescence center to a mother body material, wherein: the mother body material is constituted of at least one kind of oxide selected from alumino silicate, aluminate, silicate, tantalate, niobate, gallium oxide, and ZrO2, and the luminescence center is at least one kind selected from a rare earth metal and a transition metal which emits light when electrons excited by mechanical energy are restored to a normal state.

### BRIEF SUMMARY OF THE INVENTION

The present invention provide a light-emitting element and/or device which emits light, without the use of a chemical light-emitting material or a fuel

The light-emitting element or device emits light, even without the use of an electric power supply,

The light-emitting element or device of the invention emits light, even without the use of power supply,

The present invention is a light emitting device which includes a stress luminescent material which emits when a mechanical energy is applied thereto.

One aspect of the present invention is a light emitting device, which comprises: a container; at least one stress luminescent member movably disposed within the container; wherein at least one stress luminescent member contains a stress luminescent material disposed therein/thereon; and wherein the stress luminescent material emits light when a mechanical energy is applied thereto.

Another aspect of the present invention is a light emitting device, which comprises: a container having a stress luminescent material partially or entirely disposed therein/thereon; at least one member movably disposed within the container; and wherein the stress luminescent material emits light when a mechanical energy is applied thereto.

Other aspect of the present invention is a light emitting device, which comprises: a container; at least one member movably disposed within the container; and a stress luminescent member containing a stress luminescent material partially or entirely disposed therein/thereon; and wherein the stress luminescent material emits light when a mechanical energy is applied thereto.

In these aspects of the invention, the container is selected from a capsule, an envelope, a shell, a package, a can and a bottle.

In these aspects of the invention, the container comprises a light permeable member partially or entirely disposed in the container.

In these aspects of the invention, the container comprises a light shielding member partially or entirely disposed in the container.

In these aspects of the invention, the container comprises a light permeable member or a light shielding member having a plurality of through-holes.

In these aspects of the invention, the stress luminescent device further comprises at least one mechanical energy generator in communication with the container.

In these aspects of the invention, the stress luminescent device further comprises at least one mechanical energy generator in communication with the container, wherein the mechanical energy generator is selected from a vibrator, a gas supply device, a liquid supply device and an air bubble generator.

In these aspects of the invention, the stress luminescent device is used in the device selected from a lighting device, an emergency light, an ornament, an accessory, a toy, a playing article, a card, a dynamic or image display, a balloon, a timer and a mechanical energy sensor.

In these aspects of the invention, the stress luminescent device further comprises at least one mechanical energy generator in communication with the container, wherein the mechanical energy generator is an air bubble generator to generate air bubbles or air pockets in a liquid.

In these aspects of the invention, the stress luminescent device further comprises at least one weight fixedly or movably disposed in/on the container.

In one embodiment of the invention, the light-emitting element and/or device 10 comprises a light transmissible envelope such as a capsule, a shell or a wall) 20 having a spherical shape and having a space 40 within the envelope 20, one or a plurality of members 30 movably arranged in the space 40 and a stress luminescent i.e. a stress-induced light-emitting material which emits light by a mechanical energy i.e. a mechanical stimulus) contained in/on the envelope 20 and/or the members 30.

The light-emitting element and/or device 10 emits light when a mechanical energy is given thereto, by e.g. vibrating, swinging, turning, rotating and/or striking it.

The mechanical energy is given to the light-emitting element and/or device 10 manually or by any vibrators.

The light-emitting element and/or device 10 may offer lighting devices such as an emergency light, lighted ornaments or accessories, lighted toys and image displays in dark environments or even in day time and even indoors under lighting in rooms.

### BRIEF DESCRIPTION OF THE SEVERAL VIEWS OF THE DRAWING

For a more complete understanding of the present invention and the advantage thereof, reference is now made to the following descriptions taken in conjunction with the accompanying drawings, in which:

FIG. 1 is a schematic perspective view showing an example of a stress luminescence device 100 of a first embodiment;

FIG. 2 is a schematic elevational view of the stress light emitting device 100 of the first embodiment.

FIG. 3 is a schematic enlarged fragmentary sectional view cut along with the A-A line of FIG. 2;

FIG. 4A and FIG. 4B are schematic enlarged sectional views showing four kinds of particle-like emitters;

FIG. 5A and FIG. 5B are schematic enlarged sectional views showing four kinds of particle-like emitters;

FIG. 6A and FIG. 6B are schematic enlarged sectional views showing a wall or a shell of the hollow container 20 cut along with the line B-B of FIG. 1;

FIG. 7A and FIG. 7C are schematic enlarged sectional views showing a wall or a shell of the hollow container 20 cut along with the line B-B of FIG. 1;

FIG. 8 is a schematic elevational view showing a stress light emitting device of the third embodiment, in which a part of the stress light emitting device is shown as a cross sectional view;

FIG. 9 is the schematic perspective view showing a stress light emitting device;

FIG. 10 is a schematic partially enlarged sectional view cutting along with the line C-C of FIG. 9;

FIG. 11 is a schematic partial perspective view showing a major part of a stress light emitting device showing the fifth embodiment of the present invention;

FIG. 12 is a schematic partial perspective view of a major part of a stress light emitting device showing the sixth embodiment of the present invention;

FIG. 13 is a schematic exploded perspective view showing a stress light emitting device of the seventh embodiment;

FIG. 14 is a schematic elevational view showing a candle-like light-emitting device, in which a major part is shown as a cross section;

FIG. 15 is a schematic fragmentary sectional view showing a capsule-like light emitting device;

FIG. 16A, FIG. 16B and FIG. 16C are schematic perspective views of some light emitting devices according to the tenth embodiment;

FIG. 17A, FIG. 17B and FIG. 17C are schematic fragmentary sectional views.

FIG. 18 is a schematic elevational view of a light emitting device of 12th embodiment of the present invention, in which a part of the light emitting device is shown as a cross section;

FIG. 19 is a schematic perspective view of another light emitting device, in which showing a part of the light emitting device as a cross section;

FIG. 20 is a schematic fragmentary sectional view showing a capsule-like light emitting device 18 showing a part as a cross section;

FIG. 21 is a schematic fragmentary sectional view showing a capsule-like light emitting device 19 showing a part as a cross section;

FIG. 22A and FIG. 22B are schematic fragmentary sectional views of one mechanical energy detection device;

FIG. 23A and FIG. 23B are schematic fragmentary sectional views of one mechanical energy detection device;

FIG. 24A and FIG. 24B are schematic fragmentary sectional views of one mechanical energy detection device;

FIG. 25A and is an explanatory view of a ninteenth embodiment showing an artificial eye and FIG. 25B is a schematic fragmentary sectional view of the artificial eye shown in FIG. 25A;

FIG. 26A and FIG. 26B are schematic elevational views showing examples of ornaments or accessories;

FIG. 27A and FIG. 27B are schematic elevational views showing balloons respectively;

FIG. 28 is a schematic elevational view showing an artificial flower device according to the twenty second embodiment;

FIG. 29 is a schematic elevational view showing the dynamic exhibition device;

FIG. 30 is a schematic elevational view showing the water fall display device;

FIG. 31 is a schematic elevational view showing the dynamic lighted ornamental display, a part of which is shown as a cross section;

FIG. 32 is a schematic fragmentary elevational view showing a dynamic lighted ornamental display, of which a part is shown as a cross section;

FIG. 33 is a schematic perspective view showing a dynamic lighted display, of which a part is shown as a cross section;

FIG. 34 is a schematic explanatory view, in which a part is shown as an enlarged cross section, showing a display device for use in advertisements and public addresses;

FIG. 35 is a schematic explanatory view, in which a part is shown as an enlarged cross section, showing a display device for use in advertisements and public addresses;

FIG. 36 is a schematic elevational view of a light emitting sandglass;

FIG. 37 is a schematic perspective view of a stress lighting device;

FIG. 38 is a schematic perspective view of a stress lighting device;

FIG. 39 is a schematic perspective view showing a stress light emitting device of the thirty third embodiment, a part of which is shown as a cross section;

FIG. 40 is a schematic partial cross sectional view showing a light emitting device of the thirty fourth embodiment; and

FIG. 41 is a schematic partial cross sectional view showing a light emitting device of the thirty sixth embodiment.

### DETAILED DESCRIPTION OF THE INVENTION

Various embodiments of the present invention are described hereinafter with reference to accompanying drawings.

First Embodiment

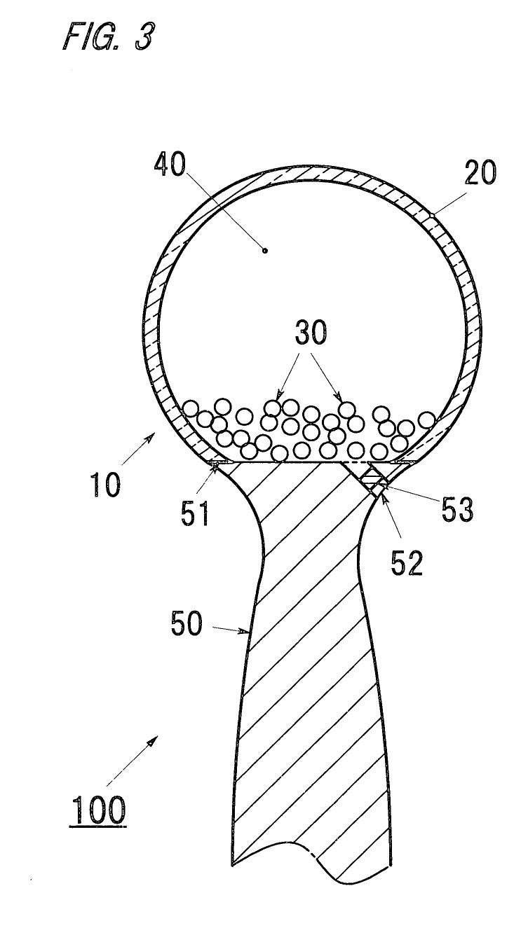

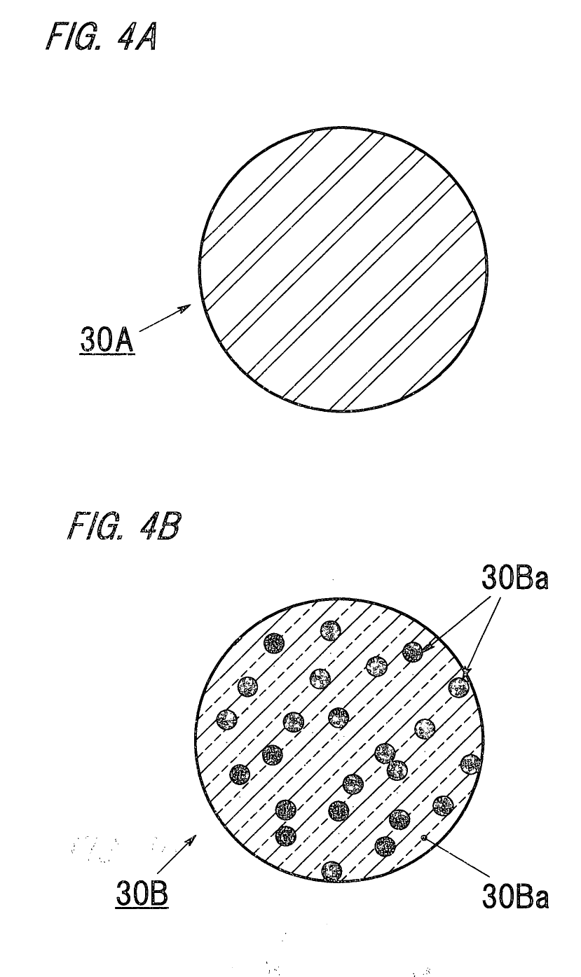

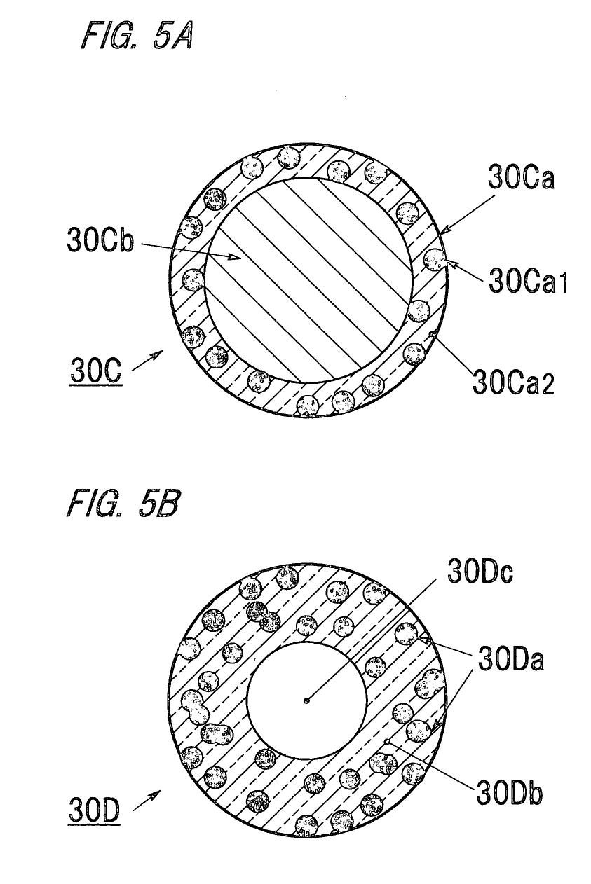

A first embodiment of the invention is explained with reference to FIG. 3, FIG. 4A, FIG. 4B, FIG. 5A and FIG. 5B.

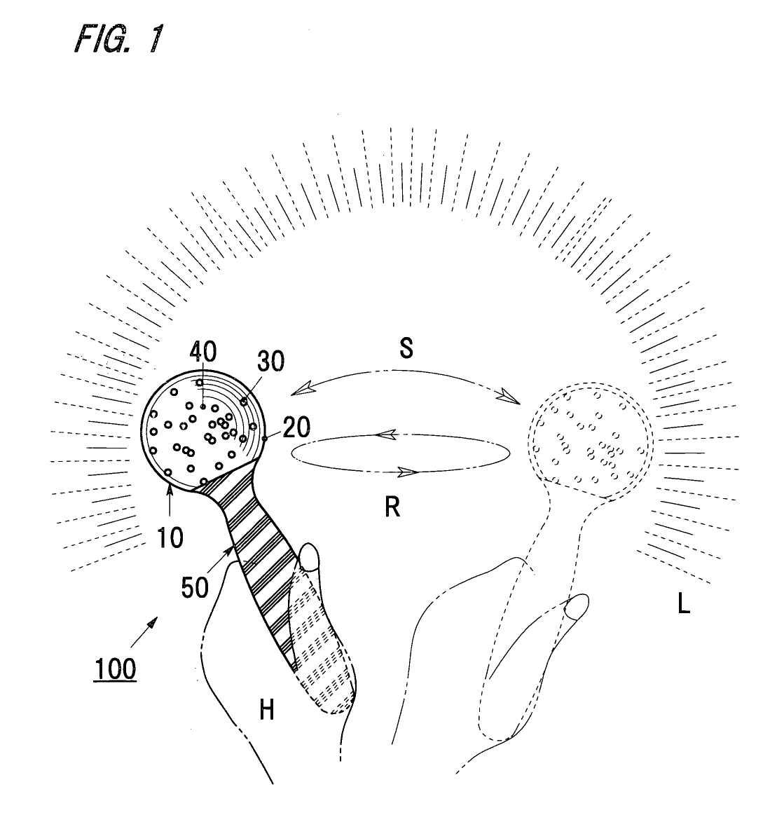

FIG. 1 is a schematic perspective view showing an example of a stress luminescence device 100 of the first embodiment.

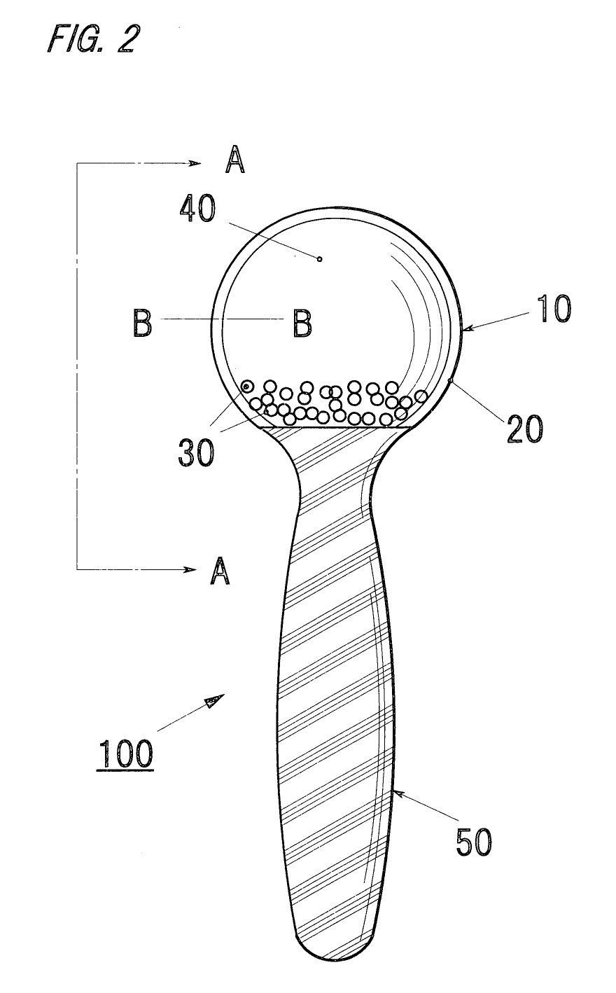

FIG. 2 is a schematic elevational view of the stress light emitting device 100 of the first embodiment.

FIG. 3 is a schematic enlarged fragmentary sectional view cut along with the A-A line of FIG. 2.

FIG. 4A, FIG. 4B, FIG. 5A, and FIG. 5B are schematic enlarged sectional views showing four kinds of particle-like emitters.

As shown in FIG. 1, FIG. 2, and FIG. 3, the stress luminescence device 100 of the first embodiment may be composed of a light emitting device 10 and an elongated member 50, in which the light emitting device 10 is fixed to the elongated member 50 at that one end.

The elongated member 50 may be a comparatively long member such as a grip and a handle.

The light emitting device 10 may be composed of a hollow container 20 having a wall and an inner space and at least one stress light-emitting member 30 movably disposed in the inner space, so that the at least one stress light-emitting member 30 can move freely within the hollow container 20.

The term “container” includes “envelope”, “capsule”, “shell”, “package”, “can” and “bottle”.

The wall may be partially or entirely composed of a light permeable (i.e. transparent or translucent) material.

The hollow container 20 may be composed of the wall, a capsule or a shell partially or entirely having a light permeable member and the inner space i.e. a cavity surrounded by the wall, in which the inner space to act as a store room 40 movably to hold or keep the at least one stress light-emitting member 30

The wall 20 or the light permeable member may be composed of a light permeable resin, a light permeable elastomer and a light permeable rubber.

The wall 20 may have a predetermined thickness e.g. about 0.1 mm to 10 mm.

The hollow container 20 may have a dome-like or spherical shaped configuration.

As the light permeable material of the hollow container i.e. the wall 20, there may be thermoplastic polymer such as acrylic resin (AC), polycarbonate resin (PC) and polyethylene terephthalate resin (PET); thermo-setting or photo-setting polymer such as epoxy resin; rubber such as synthetic rubber, polybutadiene rubber and nitrile rubber; and inorganic glass such as glass and tempered glass.

The light permeable wall 20 may be composed of a semi-transparent member having light diffusing or scattering characteristic.

The semi-transparent wall 20 may be formed in such a manner that a transparent or clear wall is treated by blasting or etching process to obtain an inner or outer roughed surface.

The semi-transparent wall 20, in stead, may be composed of a transparent or clear wall and a coating layer on that inner or outer surface using a light diffusing or scattering ink or paint.

The semi-transparent wall 20, in stead, may be composed of a transparent or clear material containing a plurality of light diffusing or scattering particles dispersed beforehand, such as white pigments, polymer beads or glass beads.

The light-emitting member 30 containing the stress luminescent material may have any form such as particle-like, powder-like, pellet-like, rod-like and bar-like shape.

A plurality of the light-emitting members 30 may preferably be enclosed in the store room 40, so that the light-emitting members 30 can move freely in the store room 40.

A handle or grip member 50 may be composed of arbitrary materials, such as a polymer, an elastomer, a wood and a metal.

As shown in FIG. 3, in this embodiment, the hollow container 20 having a dome-like shaped wall and the handle member 50 are unified firmly to be fixed together at a contact part 51 using an adhesive or a screw association.

With this embodiment, the handle member 50 has a through hole 52 to connect the store room 40 of the dome-like hollow container 20 and an exterior.

If necessary, the plug 53 may be provided which closes or opens the through-hole 52, so that the plug 53 can use for filling or exchanging the stress light-emitting member 30 to or from the store room 40 of the hollow container 20.

As shown in FIG. 3, the light-emitting member 30 contains a known stress luminescent material indicated in e.g. the patent documents as mentioned above, which emits light by adding or applying any kinds of mechanical energy.

The stress luminescent material available from Taiko Rozai Co., Ltd. (English name: Taiko Refractories Co., Ltd.) may be used for the invention (article name: “TAIKO-ML-1”), in which the main component is SrAl₂O₄:Eu, an average particle size is about 5 to 10 micro-m and the emitting spectrum is about 520 nm.

The light-emitting member 30 may be composed of a stress luminescent material itself having a stress luminescent particle.

The light-emitting member 30, in stead, is composed of a carrying member (i.e. a supporter or a substrate) and the stress luminescent material disposed therein/thereon.

The light-emitting member 30 is preferably composed of a light permeable member as the carrying member and a plurality of stress luminescent particles disposed therein/thereon.

As a material of the light permeable member for the carrying member, there may be thermoplastic polymer such as acrylic resin (AC), polycarbonate resin (PC) and polyethylene terephthalate resin (PET); thermo-setting or photo-setting polymer such as epoxy resin; rubber such as synthetic rubber, polybutadiene rubber and nitrile rubber; polymeric elastomer such as styrene butadiene elastomer and styrene isoprene elastomer; and inorganic glass such as glass and tempered glass.

The light permeable member for the carrying member may have any form such as a particle-like, powder-like, pellet-like, granule-like, bead-like, flake-like, rod-like or bar-like shaped configuration.

Liquid (not shown in FIG. 3) having suitable specific gravity such as nonflammable liquid of water and silicon oil may be filled in the store room 40.

Moreover, the specific gravity of a nonflammable liquid may be made similar to the particle-like stress light-emitting member 30.

In addition to the light-emitting member/members 30, at least one agitating member (not shown in FIG. xx) without the stress luminescent material may be enclosed in the container 20 to agitate the stress light-emitting member/members 30 when an external mechanical force is added to the container 20.

The agitating member may be composed of a mass such as a metallic ball e.g. a steel ball or a polymer ball having a specific gravity more than the specific gravity of the light-emitting member/members 30

In stead, the agitating member may be composed of a mass such as a metallic ball e.g. a steel ball or a polymer ball having a specific gravity more than the specific gravity of the light-emitting member/members 30.

When the stress luminescence device 100 receives an enough mechanical energy such as an impact and vibration, the light-emitting member/members 30 move to collide with the inside of the wall of the container 20.

At the same time, the agitating member moves or jumps to collide with, stir and agitate the light-emitting member/members 30.

The agitating member promotes a chance to make the light-emitting member/members 30 collide with the inside of the wall 20 and other light-emitting member/members 30 as much as possible, thereby, the light-emitting member/members 30 receive more mechanical energies.

As shown in FIG. 4A, a stress light-emitting member 30A may be composed of a stress luminescent particle itself.

As shown in FIG. 4B, the stress light-emitting member 30B may be composed of a transparent polymer member 30Bb containing the stress luminescent particles 30Ba dispersed therein.

The transparent polymer member 30Bb may be made of thermoplastic polymer such as acrylic resin (AC), polycarbonate resin (PC) and polyethylene terephthalate resin (PET); thermo-setting or photo-setting polymer such as epoxy resin; thermoplastic elastomer such as styrene-butadiene and polybutadiene, rubber such as synthetic rubber.

As shown in FIG. 5A, a stress light-emitting member 30C may be composed of any carrying member 30Cb and a stress light-emitting layer 30Ca partially or entirely disposed on the carrying member 30Cb.

Further, the stress light-emitting layer 30Ca may be composed of a transparent polymer binder 30Ca2 containing a plurality of stress luminescent particles 30Ca1 dispersed therein.

The carrying member 30Cb may be made of an organic substance, inorganic substance, mineral, metal, wood and vegetable seed.

The transparent polymer binder 30Ca2 may be made of a polymer material such as silicone resin, epoxy resin, acrylic resin, rubber and elastomer.

As shown in FIG. 5B, a stress light-emitting member 30D may be composed of the stress luminescent member 30B as shown in FIG. 4B and at least one air bubble or cavity 30Dc disposed therein.

That is, the stress light-emitting member 30D may be composed of a particulate transparent organic member 30Db containing the stress luminescent particles 30Da and the air bubble or cavity dispersed therein.

Although the stress light-emitting member 30A, 30B, 30C and 30D are indicated as a circular shaped configuration as shown in FIG. 4A, FIG. 4B, FIG. 5A, and FIG. 5B, the stress light-emitting member may have an arbitrary shaped configuration, such as f an ellipse form, a polygon and a rectangle.

The stress light-emitting member may have a shape of well known play card (trumps) such as a heart, club, diamond (rhombus) and spade.

A method for use of the stress luminescence device 100 is described as follows.

Referring to FIG. 1, one example of a method for use of the stress luminescence device 100 or that operating instruction is explained hereinafter. This method and operation is applicable in common also with other embodiments.

As already described in the detail in FIG. 1, the stress luminescence device 100 may be composed of the stress light emitting device 10 and the handle 50.

The light emitting device 10 may be composed of the container 20 having the domed or spherical light permeable wall and the inner space (store room) and the stress luminescent 30 movably disposed in the inner space, so that the light-emitting member 30 can move freely within the hollow container 20.

A user grips the handle 50 of the stress luminescence device 100 with the hand “H: hand”, shakes “S: shake” it right and left, multiple times or rotates “R: rotate” it, in which this handling method is similar to a playing method of percussion or shaker musical instruments, i.e. South American native maracas and the handling is easy.

Corresponding to a motion of this hand “H, the stress luminescent members 30 are collided, contacted, rubbed with the inside surface of the spherical wall 20, or some of the stress luminescent members 30 are collided, contacted, rubbed with other stress luminescent members 30.

Thereby, the stress luminescent members 30 receive enough mechanical energies enough to emit visible light (L: light) therefrom and the user can see the light “L” through the light permeable wall 20.

In this example, a dynamic mechanical energy is given to the stress light emitting device 10 by a human power, and the stress light emitting device 10 emits light with the given mechanical energy.

Therefore, an electric power and a fuel are not needed for making a light emission of the stress light emitting device 10.

When an actuation of the user's hand stops, the stress light emitting device 10 ends to emit the light “L” after a moment or a short time.

If the stress light emitting device 10 contains the stress luminescent material with long afterglow nature, the stress light emitting device continues to emit light “L” for a comparatively long time.

If the stress light emitting device 10 contains the stress luminescent material and a storage phosphor with a long afterglow nature, the stress light emitting device continues to emit light “L” for a comparatively long time.

Another method for use of the stress luminescence device 100 is described as follows.

When the stress light emitting element 100 is hit with objects such as a wall or a floor, the stress light emitting element 10 (device) a mechanical shock from the objects and thereby the stress light emitting element 10 emits light.

Other method for use of the stress luminescence device 100 is described as follows.

When the stress light emitting element 100 comes in contact with a mechanical power generator such as a vibrator, the stress light emitting element 100 device a mechanical stress from the mechanical power generator, thereby the stress light emitting element 100 emits light.

Second Embodiment

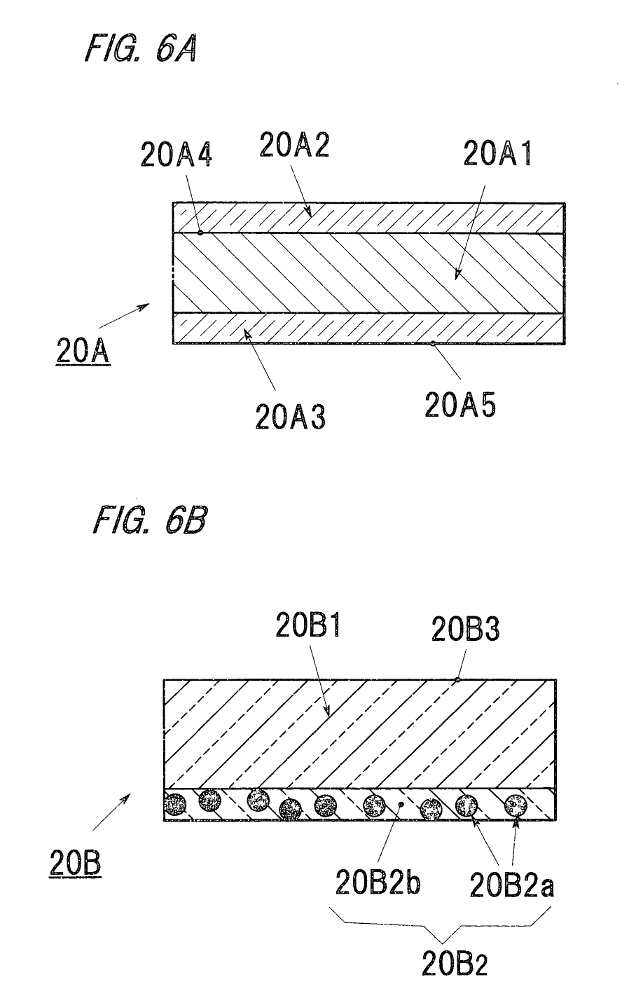

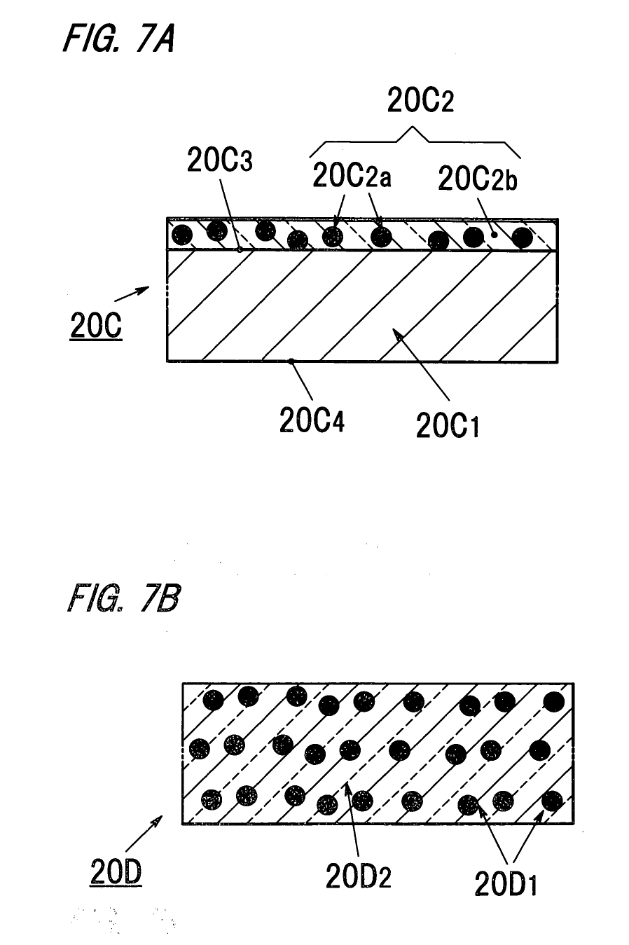

A second embodiment of the present invention is explained with reference to FIG. 6A, FIG. 6B, FIG. 7A, FIG. 7C, and FIG. 1 to FIG. 3).

Since FIG. 1, FIG. 2 and FIG. 3 are already explained in the detail herein-before, the explanation of these drawings is omitted here.

FIG. 6A, FIG. 6B, FIG. 7A and FIG. 7C are the schematic enlarged sectional views showing a wall or a shell of the hollow container 20 cut along with the line B-B of FIG. 1.

The particulate member/members 30 in the first embodiment contain the stress luminescent material therein/thereon.

On the other hand, in the second embodiment, the particulate member/members do not contain the stress luminescent material and a wall or shell 20 contains the stress luminescent material therein/thereon.

Since other configurations of the second embodiment are similar to the configurations of the first embodiment, the common explanation is omitted.

As shown in FIG. 6A, a container 20A may be composed of a wall 20A1 and a stress luminescent film 20A2 formed partially or entirely on the wall 20A1.

The wall 20A may be made of a non light permeable member with a thickness e.g. from 0.1 to 10 millimeters and the stress luminescent film 20A2 is layered on an outer surface 20A4 of the wall 20A1 by e.g. a vacuum deposition or sputtering process.

When the stress luminescent film 20A2 is formed in the outer surface 20A4 of the wall 20A1, the wall 20A1 may be composed of metals with non-transparent nature such as iron, copper, brass, tin, stainless steel and titanium having an adequate flexibility and/or shock resistance.

The wall 20A1, in stead, may be composed of any plastic material.

The wall 20A1, in stead, may be composed of a fiber reinforced plastic (FRP) having fibers such as polymer fibers, glass fibers, carbon fibers and ceramic fibers including a plastic material.

If the wall 20A is made of a light permeable member, the stress luminescent film 20A2 may be layered on an inner surface 20A3 (or the outer surface 20A4) of the wall 20A1 by e.g. the vacuum deposition or sputtering process. 20A1 and 20A2

When the stress luminescent-material film 20A3 is formed in the inner surface 20A5 of the wall 20A1, the wall 20A1 is composed of the light permeable material in order to allow light emitting from the stress luminescent film 20A3 to pass the wall 20A1 to output.

As for the light permeable material of the wall 20A1, any transparent polymer material or glass material can be used.

The transparent polymer container, wall 20A1 may be made of transparent polymer such as acrylic acid resin (AC), polycarbonate resin (PC), polyethylene terephthalate resin (PET), epoxy resin, natural rubber and synthetic rubber.

The transparent polymer container or wall 20A1, in stead, may be made of inorganic glass such as general glass and tempered glass.

The stress luminescent film 20A4 may be formed on the inner surface 20A3 of the wall 20A1 by the laying process similar to the stress luminescent film 20A2.

As shown in FIG. 6B, a container or wall 20B may be composed of a transparent wall 20B1 with a predetermined thickness of about 0.1 to 10 millimeters and a stress luminescent film 20B2 formed partially or entirely on an inner surface 20B4 (and an outer surface 20B3) of the transparent wall 20B1.

The stress luminescent film 20B2 may further composed of a transparent binder material 20B2b e.g. transparent polymer or glass containing a plurality of stress luminescent particles 20B2a in the transparent binder material 20B2b.

As shown in FIG. 7A, a container or wall 20C may be composed of a transparent or non-transparent wall 20C1 with a predetermined thickness of about 0.1 to 10 millimeters and a stress luminescent film 20C2 formed partially or entirely on an outer surface 20C3 of the wall 20C1.

The stress luminescent film 20C2 may further composed of a transparent binder material 20C2b e.g. transparent polymer or glass containing a plurality of stress luminescent particles 20C2a in the transparent binder material 20C2b.

As shown in FIG. 7B, a container or wall 20D may be composed of a transparent wall 20D1 with a predetermined thickness of about 0.1 to 10 millimeters containing a plurality of stress luminescent particles 20D1 dispersed in the transparent wall 20D1.

The container or wall 20D with the stress luminescent particles 20D1 may be formed in such a manner that a molding material composed of a transparent thermoplastic polymer such as acrylic acid resin (AC), polycarbonate resin (PC) containing the stress luminescent particles 20D1 is prepared beforehand and the molding material is molded using a mold pattern corresponding to a pattern of the container 20D by applying a sufficient heat and pressure.

The above-mentioned “the movable light emission member e.g. 30” and “the light emission container wall e.g. a combination of 20A1 and 20A2” may be combined together, in such a manner that the movable light emission member/members are movable enclosed in the light emission container wall.

In this case, the light brightness of emission is too strong since the emission from both of “light emission member” and “light emission container wall” are added.

Third Embodiment

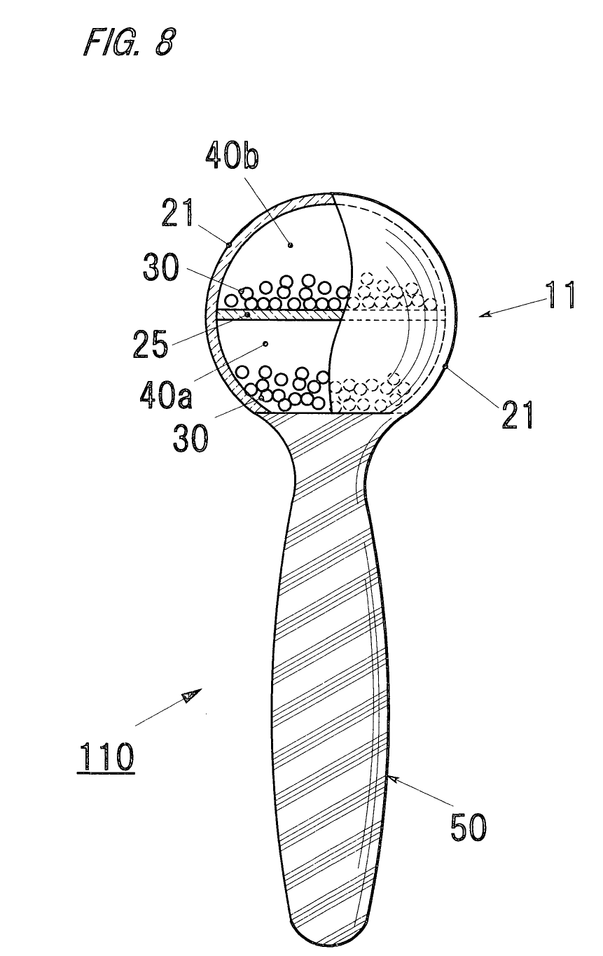

A third embodiment of the invention is explained with reference to FIG. 8. FIG. 8 is a schematic elevational view showing a stress light emitting device of the third embodiment, in which a part of the stress light emitting device is shown as a cross sectional view.

The stress light emitting device 110 of the third embodiment is a modification of the stress light emitting device 100 of the first and second embodiments.

As shown in FIG. 8, the stress light emitting device 110 is composed offs of a grip or handle (an elongated member) 50 and a light emitting device 11 fixed to an end of the elongated member 50.

The light emitting device 11 may be composed of a hollow container 20 having a light permeable (transparent or translucent) characteristic and one or more stress light-emitting members 30 containing a stress luminescent material therein/thereon, in which the stress light-emitting members 30 are movably accommodated in an interior space of the hollow container 20.

The hollow container 20 has a wall or shell 21 having a substantially domed or hollow shaped member and a light permeable or light reflective partition wall 25.

The two (or more) spaces surrounded by the wall or shell 21 and the partition wall 2 act as rooms 40a and 40b movably to accommodate the movable light emitting members 30 with the stress luminescent material as shown in FIG. 4A, FIG. 4B, FIG. 5A and FIG. 5B.

In stead of the movable light emitting members 30, the movable members without the stress luminescent material and the light emitting wall 21 containing the stress luminescent material disposed therein/thereon.

The movable light emitting members 30 and the light emitting wall 21 may be used to enhance brightness.

Fourth Embodiment

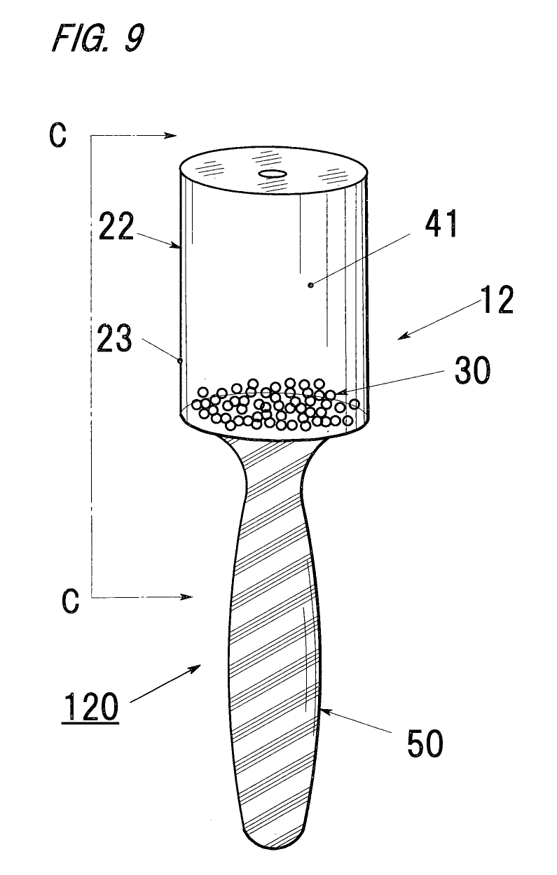

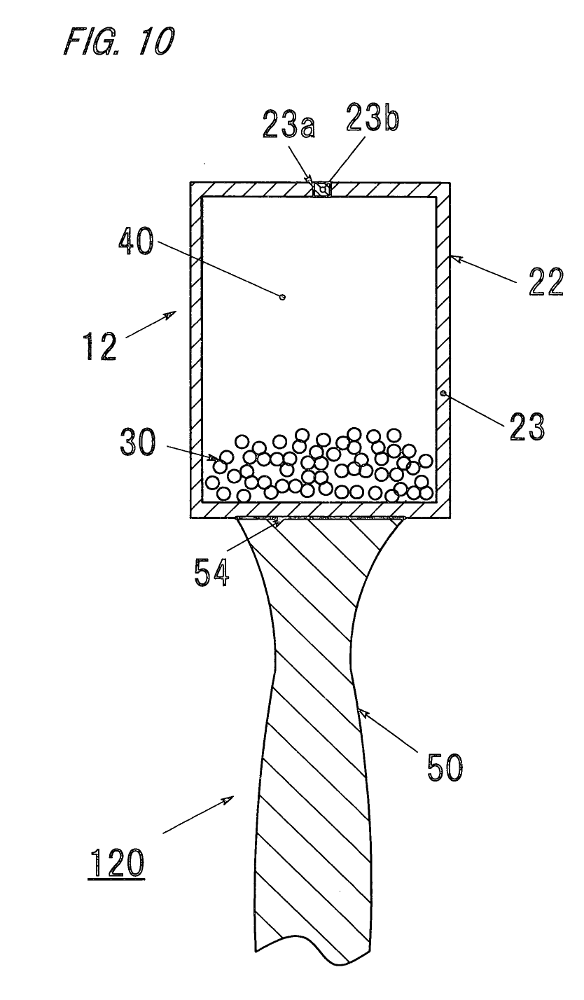

A fourth embodiment of the invention is explained with reference to FIG. 9 and FIG. 10.

FIG. 9 is the schematic perspective view showing a stress light emitting device.

FIG. 10 is a schematic partially enlarged sectional view cutting along with the line C-C of FIG. 9.

As shown in FIG. 9 and FIG. 10, a stress light emitting device 120 may be composed of a long member 50 acting as a grip or handle and a stress luminescent device 12 fixed to one end of the long member.

A stress light emitting device 12 is composed of a cylindrical member (hollow container) 22 having a space or cavity acting as a room 41 surrounded by a light permeable (i.e. transparent or semi-transparent) cylindrical wall and one or more stress light-emitting members 30 movably accommodated in the room 41.

The cylindrical member (hollow container) 22 may be composed of a disc-like member at that top portion having a hole 23a and a detachable lid 23b to cover the hole 23a.

The stress light-emitting members 30 can be taken in or out from the hole 23a.

Another disc-like member disposed at a bottom of the cylindrical member 22 may be firmly fixed to the top face of an elongated member 50 (a handle or grip) with an adhesive 54 etc.

Since the stress light-emitting members 30 are already described hereinbefore in detail with reference to FIG. 4A, FIG. 4B, FIG. 5A and FIG. 5B, the explanation is omitted here.

In stead of the stress light-emitting member 30 containing the stress luminescent material therein/thereon, the wall 21 may be made to contain the stress luminescent material therein/thereon, using the non-light-emitting member which does not contain the stress luminescent material, as shown in FIG. 6A, FIG. 6B, FIG. 7A and FIG. 7B.

The stress luminescent material may be included in the stress light-emitting member 30 and also in the light-emitting wall 21.

Fifth Embodiment

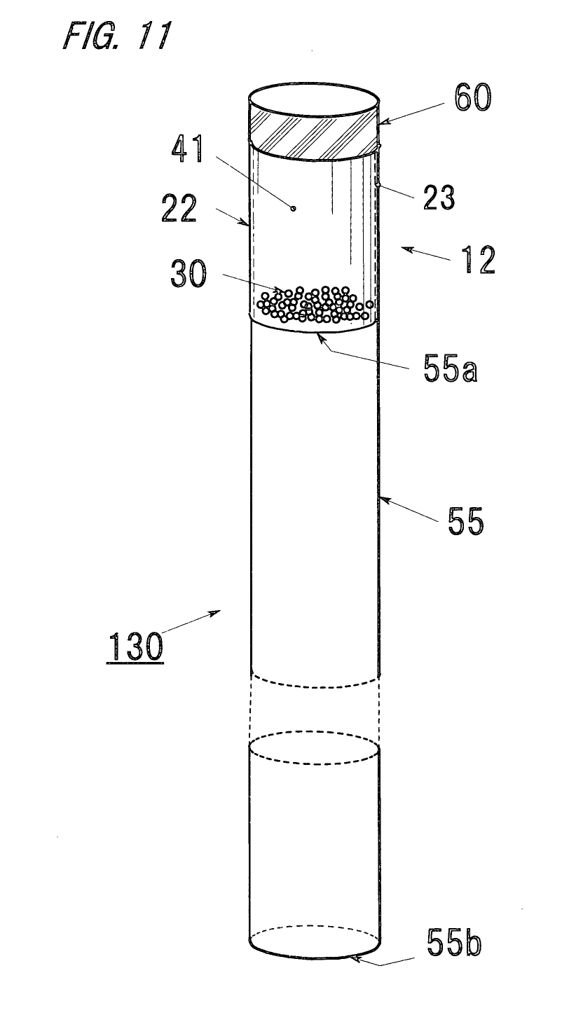

A fifth embodiment of the present invention is explained with reference to FIG. 11.

FIG. 11 is a schematic partial perspective view showing a major part of a stress light emitting device showing the fifth embodiment of the present invention.

As shown in FIG. 11, a stress luminescence device 130 of the fifth embodiment of the invention may be composed of an elongated member 55, a stress light emitting device 12 fixed to one end 55a of the elongated member 55 and a weight member 60 fixed to a top face of the stress light emitting device 12.

The stress light emitting device 12 may be composed of the hollow cylindrical member 22 having the transparent or semi-transparent wall 23, the room 41 surrounded with the wall 23 and the stress luminescent members 30 movably enclosed within the room 41, which already is described with reference to FIG. 9 and FIG. 10.

The elongated member 55 may be composed of a pillar-shaped solid or tubular member with a predetermined length.

As shown in FIG. 11, in this embodiment, the stress luminescence device 130 may be composed of a cylindrical configuration with a predetermined diameter as a whole, in which the stress luminescent device 12, the weight member 60 and the elongated member 55, all may be composed of cylindrical shapes having the same diameter.

The elongated member 55 may be made of a flexible or elastic material such as a rubber, a polymer elastomer, a coil metallic spring and an elastic composite member thereof.

Furthermore, the elastic composite member may be composed of an elongated coil spring coated with the rubber or the elastic polymer, a cylindrical rubber or elastic polymer member having an elongated coil spring embedded therein or a cylindrical rubber or elastic polymer member having an elongated coil spring wounded thereon.

The weight member 60 may be composed of known metals such as iron, copper, zinc and tin, or metallic compounds, having larger specific gravity than the elongated member 55.

When a user grips one end 55b of the elongated member 55 and gives manually a mechanical energy or an external force to the elongated member 55 and the stress luminescence device 130 by e.g. shaking the right and left directions or the upper and lower directions, rotating or vibrating it.

At that time, a reversible deformation of the elastic elongated member 55 such as refraction, vibration or curvature strengthens the mechanical energy or the external force which is transmitted to the stress light emitting device 12, thereby the stress light emitting device 12 can emit light having a high luminescence of brightness therefrom.

Sixth Embodiment

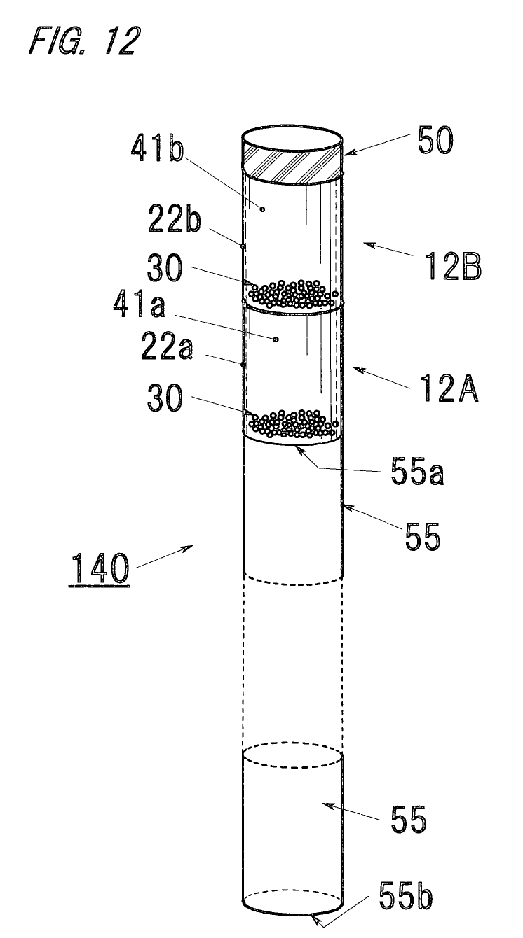

A sixth embodiment of the present invention is explained with reference to FIG. 12.

FIG. 12 is a schematic partial perspective view of a major part of a stress light emitting device showing the sixth embodiment of the present invention.

The sixth embodiment of the present invention is a modification of the fifth embodiment of the present invention described with reference to FIG. 11.

As shown in FIG. 12, a stress luminescence device 130 of the sixth embodiment of the invention may be composed of an elongated member 55, a first stress light emitting device 12A fixed to one end 55a of the elongated member 55, a second stress light emitting device 12B fixed to a top end of the first stress light emitting device 12A and a weight member 60 fixed to a top end of the second stress light emitting device 12B.

The first stress light emitting device 12A and the second stress light emitting device 12B each may have almost similar constitution to the stress light emitting device 12 described in FIG. 9 and FIG. 10.

The first stress light emitting device 12A and the second stress light emitting device 12B may be respectively composed of first and second light permeable hollow cylindrical members 22a and 22b, first and second rooms 41a and 41b surrounded by the cylindrical members 22a and 22b and stress luminescent members 30 movably enclosed within the rooms 41a and 41b.

A weight member 50 may be fixed to a top of the second cylindrical members 22b.

Alternatively, the elongated member 55 may be provided with the first and stress light emitting devices 12A and 12B in such a manner that the first stress light emitting device 12A is fixed to one end of the elongated member 55 and the second stress light emitting device 12B is fixed to another end of the elongated member 55.

Therefore, a user can grip a substantially middle portion of the elongated member 55 in order to give a mechanical energy to opposed t stress light emitting devices 12A and 12B.

Further, one weight member 50 may be fixed to an exposed end of the first stress light emitting device 12A and another weight member 50 may be fixed to an exposed end of the first stress light emitting device 12B.

Seventh Embodiment

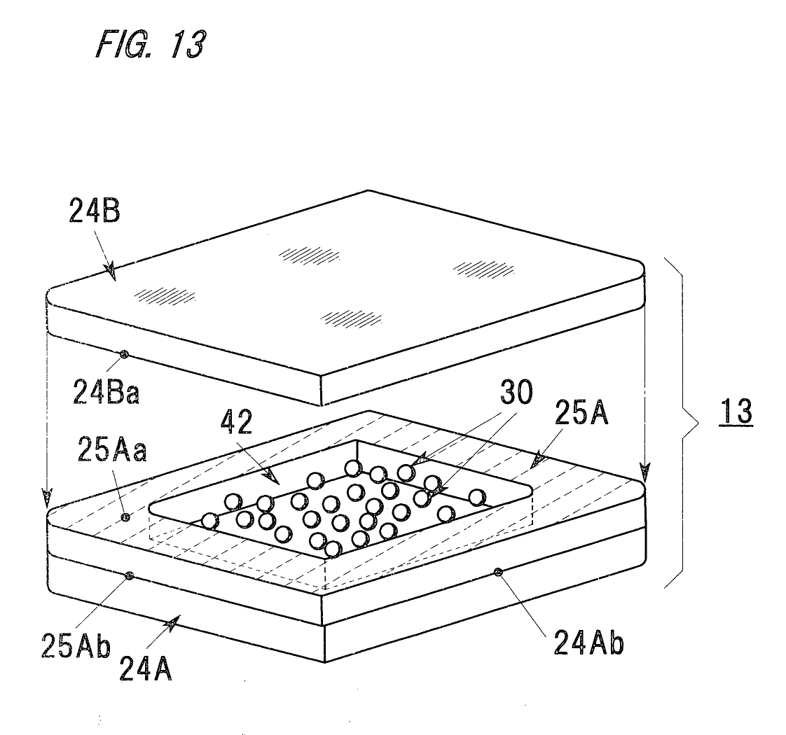

A seventh embodiment of the present invention is explained with reference to FIG. 13.

FIG. 13 is a schematic exploded perspective view showing a stress light emitting device of the seventh embodiment.

As shown in FIG. 13, a light emitting device 13 of the seventh embodiment may be composed of a first sheet 24A, a second sheet 24B and a spacer 25A with an opening 42 which is disposed between the first sheet 24A and the second sheet 24B, to produce a space (or gap) 42 within the opposed sheets 24A and 24B, in which one or both of the sheets 24A and 24B are made of light permeable material.

Further, one or more particle-like light-emitting members 30 are inserted in the space (or gap) 42 and the light-emitting members 30 can move freely in the space 42.

The particle-like light-emitting members 30 contain a stress luminescent material disposed thereon/therein.

The light emitting device 13 may be made in such a manner that the first sheet 24A, the spacer 25A with the opening 42 and the second sheet 24B are layered together in that order.

The light-emitting members 30 may be preliminarily put in the space 42 produced within the two opposed sheets 24A and 24B and the opening 42 of the spacer 25A.

The first sheet 24A, the spacer 25A and the second sheet 24B are bonded together by a heat welding process or by using any adhesives in order to form a unitary sheet-like or card-like light emitting laminate 13 or a light emitting sheet or card 13.

The first sheet 24A, the second sheet 24B and the spacer 25A may be selected from any polymer sheets such as Poly methyl methacrylate (PMMA), Polycarbonate (PC), Polyethylene terephthalate (PET), Poly-vinyl chloride and Poly amid.

In stead of the polymer sheets, the first sheet 24A, the second sheet 24B and the spacer 25A may be selected from papers or artificial papers.

As shown in FIG. 13, the first sheet 24A and the second sheet 24B may have a rectangular shape with the same size.

As shown in FIG. 13, the spacer 25A may have a rectangular flame-like shape with a rectangular opening 42.

The sheet-like spacer 25A may be composed of a hot melt sheet, a double-sided adhesive sheet containing spacer particles or any sheet with adhesive layer preliminarily coated on both surfaces.

This light emitting device 13 can be formed as a card such as a credit card, an ATM card, a commuter pass card, etc.

Therefore, this thin shaped light emitting card 13 is convenient to put into a pocket in a dress, a wallet, a pass holder and a bag and can always carry around with users.

The light emitting card 13 is very useful as an emergency light at the time of an electric power failure or night time, since batteries are not needed unlike a battery powered flashlight.

One example of a card sized stress light emitting device)

The first seat 24A and the second seat 24B may be composed of a substantially rectangular polymer seats such as polyester or poly-vinyl chloride having a predetermined dimension prescribed to a credit card, a bank card or a commuter pass card.

One or both of the first seat 24A and the second seat 24B are transparent or semi-transparent.

The polymer seats may have a thickness from about 10 micron to about 1,000 micron, for example around 50 micron.

The sheet-like spacer 25A may be composed of a rectangular flame-like polymer sheet having a punch-hole 25B in an inner portion of the sheet 25A.

The punch-hole 25B may have any pattern such as a rectangular shape (FIG. 13), an ellipse shape, a polygon shape, satellite shape, a moon shape, a solar shape, a heart shape and a numerical shape.

The sheet-like spacer 25A may have a thickness between about 10 microns and about 1000 microns, for example, 500 micron.

The first seat 24A and the sheet spacer 25A and the second seat 24B are laminated together in that order to form a sheet-like card.

The stress luminescent members 30 such as particulate stress luminescent members are inserted in the inner space 25B between opposed inner surfaces of the both sheets 24A and 24B.

The particulate stress luminescent members 30 each may have a mean diameter of about 10 micron to about 300 micron that is smaller than a thickness of the space, thereby the stress luminescent members 30 can be freely moved in the space 25B of card sized stress light emitting device.

Thus, the stress light emitting device 13 convenient for carrying of card size can be obtained, for example, at the time of the need, some stress luminescence cards 13 can be grasped by hand, it can be swayed, and light can be made to emit by easy actuation of giving vibration etc.

The stress light emitting device 13 may be provided with the seat spacer 25A having a plurality of openings (i.e. aperture or space) with any pattern configuration between the first seat 24A and the second seat 24B and the particulate stress luminescent members 30 are movably enclosed in the openings to form a unitary stress light emitting sheet.

The openings 25B of the seat spacer 25A may have any shaped pattern such as a rectangular shape, an ellipse shape, a polygon shape, satellite shape, a moon shape, a solar shape, a heart shape and a numerical shape.

This stress luminescence sheet 13 is applicable to the usual printed matter, such as books e.g. picture-books or comics, postcards, greeting cards, e.g. New Year's card, Christmas cards, birth day congratulation cards and marriage congratulation cards, which can be made to emit light in any pattern configuration, when it receives any external force.

The stress luminescence sheet 13 with any pattern configuration may be stuck on the usual printed matter.

The stress luminescence sheet 13 can be made to emit visible light when a user shakes it manually by grasping a part of the sheet 13 with the hand.

The stress luminescence sheet 13 may be made to emit visible light when the sheet 13 is subjected to contact with any vibrator such as a mechanical, an electro-magnetic or a piezo-electric vibrator.

The stress luminescence sheet 13 may emit an afterglow of predetermined time after impressing mechanical energy, if the stress light-emitting member 30 has an afterglow characteristic.

The stress luminescence sheet 13, in stead, may emit an afterglow of predetermined time after impressing mechanical energy, if the particle-like stress light-emitting member 30 contains a light storage phosphor having an afterglow characteristic excited by light from the stress luminescent material contained in/on the stress light-emitting member 30.

Eighth Embodiment

An eighth embodiment of the present invention is a modification of the five embodiment of the present invention explained hereinbefore referring to FIG. 11.

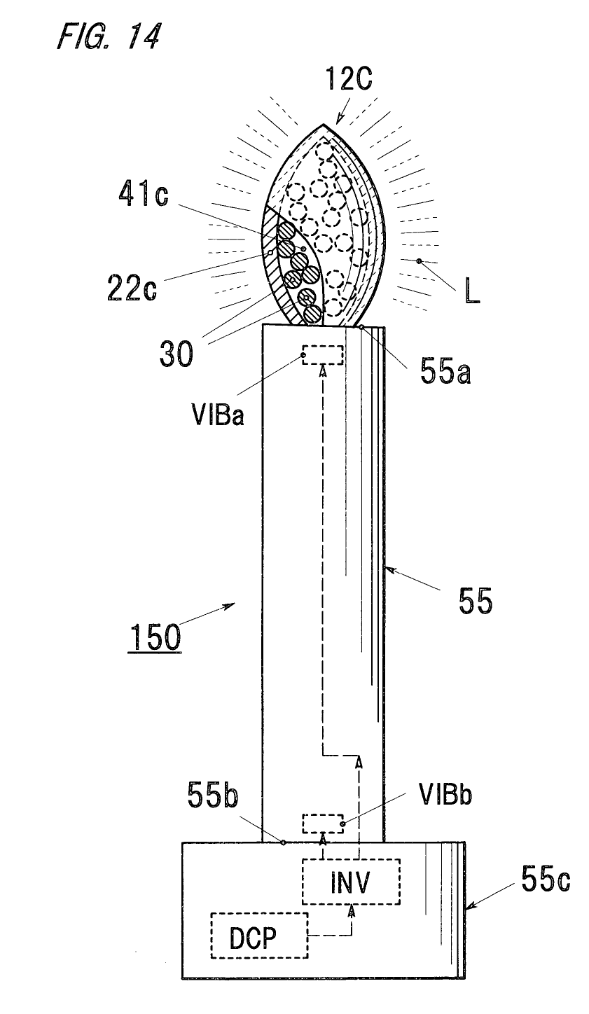

In this eighth embodiment of the present invention, a light-emitting device which imitates a candle is disclosed referring to FIG. 14.

FIG. 14 is a schematic elevational view showing a candle-like light-emitting device, in which a major part is shown as a cross section.

As shown in FIG. 14, the candle-like light-emitting device 150 may be composed of a flame-like stress light emitting device 12C and an elongated member 55 e.g. a cylinder or rod.

The flame-like stress light emitting device 12C is fixed to a top end 55a of the cylinder 55 at that bottom.

The flame-like stress light emitting device 12C has a flame-like appearance which imitates a flame of a candle.

The flame-like stress light emitting device 12C may be composed of a flame-like shaped, transparent wall 23C, a hold room 41C which is a space surrounded by the wall 23C and two or more particle-like stress light-emitting member 30 containing the stress luminescent material movably housed in the room 41C.

The elongated member 55 is fixed to a base 55c at that other end 55b.

The base 55c may have a hollow space to accommodate an inverter “INV” and a DC battery “DCP” to supply electricity to the inverter “INV”.

A vibrating element “VIBa” e.g. a piezo-electric element may be housed near the top end 55a of the elongated member 55, so as to have a vibrating coupling directly with the flame-like stress light emitting device 12C.

Another piezo-electric element “VIBb”, instead of the piezo-electric element “VIBa” may be provided near the bottom end 55b of the cylinder 55, so as to a mechanical coupling indirectly with the flame-like stress light emitting device 12C via a length of the elongated member 55.

The elongated member 55 may be composed of a flexible or an elastic member made from a rubber, an elastomer resin, an elastic metal e.g. a metal coil spring and that combination.

When the DC power supply “DCP” supplies DC voltage to the inverter “INV”, the inverter “INV” changes DC voltage to AC voltage/electric pulses which is applied to the piezo-electric element “VIBa” or “VIBb” to generate an alternate mechanical vibration which may include sonic or ultrasonic vibration.

The alternate vibration generated in the piezo-electric element “VIBa” is transmitted directly to the flame-like stress light emitting element 12C, or the alternate vibration generated in the piezo-electric element “VIBb” is transmitted indirectly to the flame-like stress light emitting element 12C via the length of the elongated member 55.

At that period, the particulate light emitting members 30 move intensely to right and left, front and back to make collision, friction and touch with an inner surface of the flame-like wall 23C or with other particulate light emitting members 30.

As a result, the particulate light emitting members 30 emit visible light “L” and the light is transmitted through the flame-like wall 23C made of transparent or scattering material to outside.

Thereby, observer/observer can see the flame-like stress light emitting device 12C as if a flame is lighted from the candle.

In stead of the piezo-electric vibrator “VIBa” or “VIBb”, a manual shaking, an electro-magnetic vibrator and a vibrating motor can be used.

Ninth Embodiment

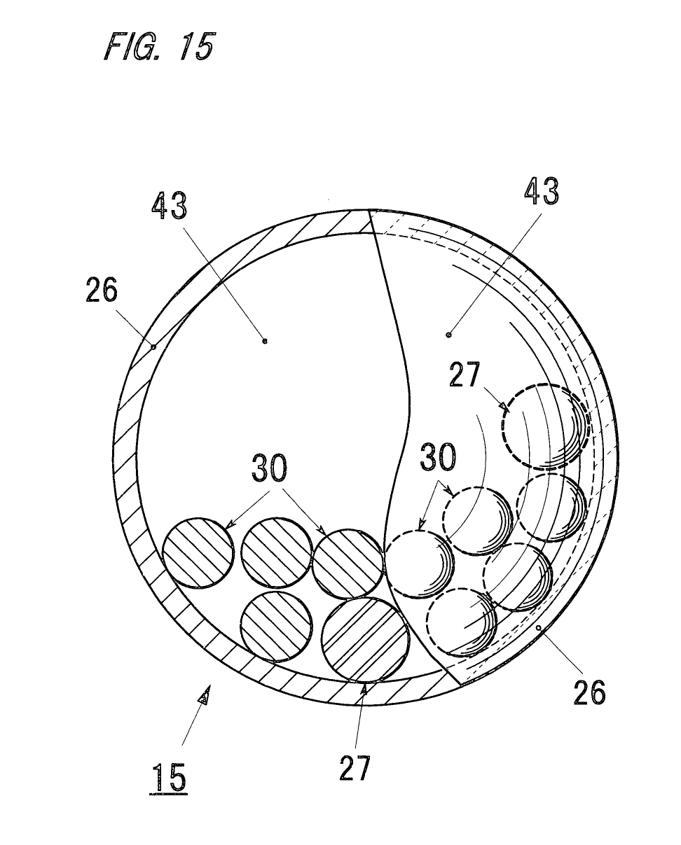

A ninth embodiment of the present invention is explained with reference to FIG. 15.

FIG. 15 is a schematic fragmentary sectional view showing a capsule-like light emitting device.

As shown in FIG. 15, the capsule-like light emitting device 15 may be composed of a shell (i.e. capsule) 26 and one or more stress luminescent cores 30 containing a stress luminescent material movably enclosed in an inner space of the shell 26.

The shell 26 may have any shape such as spherical shape.

Since the shell 26 may have a light permeable wall material similar to that of the walls 20, 21, 22a, 22b, 22c and 23 that are described hereinbefore in some embodiments, the description is omitted here in detail.

Moreover, the shell 26 may contain a stress luminescent material thereon/therein similar to that of the walls 20A, 20B, 20C, 20D and 26 that are described hereinbefore.

Since the stress luminescent cores 30 may be composed of the same material and composition as that of the stress luminescent members 30, 30A, 30B, 30C and 30D already mentioned above, the description is omitted here in detail.

When an external force is applied to the capsule-like light emitting device 15, the stress luminescent cores 30 freely move within the inner space so as to make contact, collision and friction with an inner surface of the shell wall 26 and some stress luminescent cores 30 make contact, collision and friction with other stress luminescent cores 30.

At that period, the stress luminescent cores 30 emit visible light since they receive a mechanical energy of the external force, so that observer/observers can see the visible light via the light permeable shell 26.

Furthermore, one or more stirring (or agitating) members 27 may be movably accommodated in the inner space of the shell 26.

The stirring (or agitating) member 27 may be composed of a metal or resin weight having any shape e.g. a circular shape heavier than the stress luminescent core 30.

Since the stirring (or agitating) member 27 moves feely at random within the shell 26 when sufficient eternal force is applied thereto and it stirs or agitates the stress luminescent cores 30, the stress luminescent cores 30 can emit light having an enhanced luminescence.

The light emitting device 15 may have any dimension such as comparatively large size (e.g. a balloon for advertisement or meteorological observation), medium size (e.g. a ball for sports), small size (e.g. a capsule-like tablet) and microscopic size.

Tenth Embodiment

A tenth embodiment of the present invention is some modifications of the ninth embodiment.

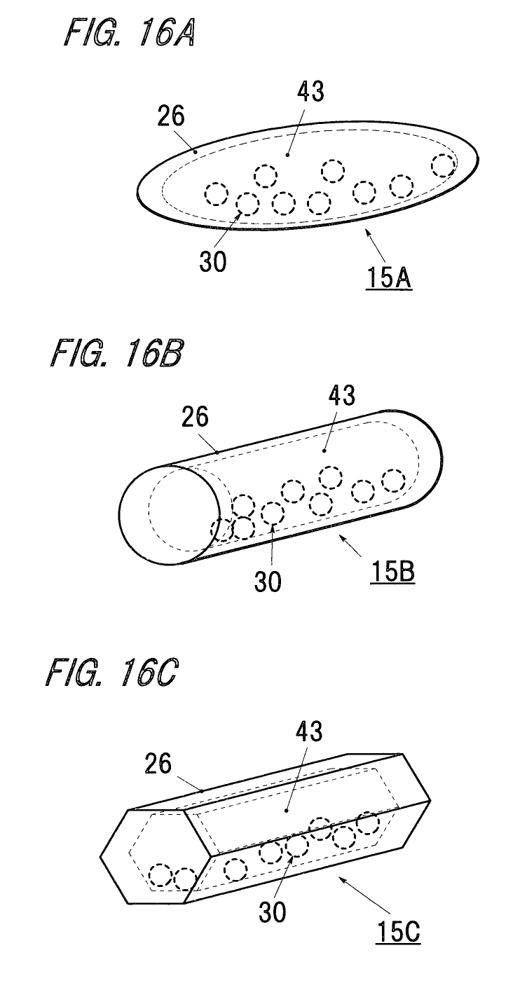

The tenth embodiment of the present invention is explained with reference to FIG. 16A, FIG. 16B and FIG. 16C.

FIG. 16A, FIG. 16B and FIG. 16C are schematic perspective views of some light emitting devices according to the tenth embodiment.

As shown in FIG. 16A, FIG. 16B and FIG. 16C, light emitting devices 15A, 15B and 15C each is composed of a shell (i.e. capsule) 26 and one or more stress luminescent cores 30 containing a stress luminescent material movably enclosed in an inner space 43 of the shell 26, that is basically similar to the light emitting devices 15 of the ninth embodiment.

The light emitting devices 15A, 15B and 15C as shown in FIG. 16A, FIG. 16B and FIG. 16 C have the configuration of an ellipse shape, a cylindrical shape and a polygon pillar shape respectively.

Eleventh Embodiment

Some light emitting devices according to an eleventh embodiment of the present invention is other modifications of the light emitting devices 15 described hereinbefore, mainly the configuration differs from the light emitting devices 15.

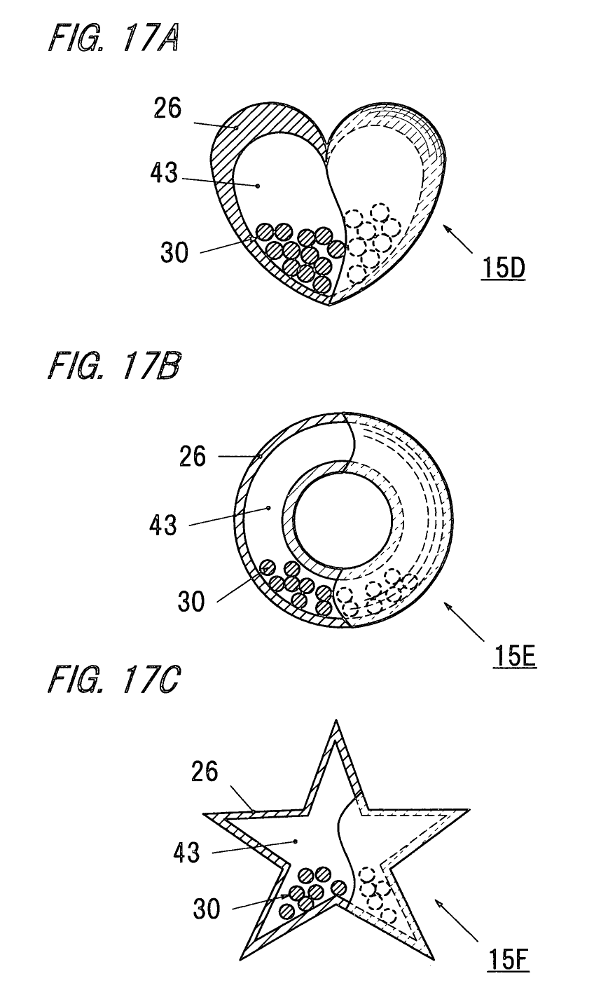

The eleventh embodiment of the present invention is explained with reference to FIG. 17A, FIG. 17B and FIG. 17C.

FIG. 17A, FIG. 17B and FIG. 17C are schematic fragmentary sectional views.

As shown in FIG. 17A, FIG. 17B and FIG. 17C, light emitting devices 15D, 15E and 15F each is composed of a shell (i.e. capsule) 26 and one or more stress luminescent cores 30 containing a stress luminescent material movably enclosed in an inner space 43 of the shell 26, that is basically similar to the light emitting devices 15 of the ninth embodiment.

As shown in FIG. 17A, a light emitting device 15D may have an outer configuration similar to that of a playing card, such as heart-like, diamond-like, crab-like and a spade-like outer shape, in which the light emitting device 15D has a substantially transparent hollow shell 26 and stress luminescent cores or particles 30 movably enclosed within shell 26.

As shown in FIG. 17B, a light emitting device 15E may have a circular outer configuration similar to that of an alphabetical character “O” shape, in which the light emitting device 15E has a substantially transparent hollow circular shell 26 and stress luminescent cores or particles 30 movably enclosed within shell 26.

The light emitting device 15E may have the configuration similar to that of any alphabetical characters or numerals.

As shown in FIG. 17C, a light emitting device 15F may have any outer configuration designed for use in ornaments, indicators, markers, signs and displays, for example, star-like, solar-like, sunflower-like and moon-like shapes, in which the light emitting device 15F has a substantially transparent hollow shell 26 and stress luminescent cores or particles 30 movably enclosed within shell 26.

The capsule-like light emitting devices 15, 15A, 15B, 15C, 15D, 15E and 15F may have an inflatable elastic gas/liquid tight shell 26 made of a light permeable rubber or polymer, light permeable gas/liquid inserted into an inner space 43 of the shell 26 and particulate stress emitting members 30 movably enclosed within the shell 26 beforehand.

The capsule-like light emitting devices 15, 15A, 15B, 15C, 15D, 15E and 15F may have a balloon 26 made of a light permeable rubber or polymer membrane, light permeable helium gas having a specific gravity lower than air inserted into an inner space 43 of the balloon 26 and particulate stress emitting members 30 movably enclosed within the balloon 26 beforehand.

This balloon 26 floating in the air can emit visible light when it shakes under the effect of a wind.

The illuminating balloon 26 can be used in a toy, a play, an amusement event, an advertisement and a meteorological observation.

The capsule-like stress light emitting element 15,15A, 15B, 15C, 15D, 15E and 15F can be made to a yo-yo balloon toy.

The yo-yo balloon toy 15, 15A, 15B, 15C, 15D, 15E or 15F is composed of an inflated balloon 26 made of light permeable membrane filled with compressed air and some amount of light permeable liquid together with stress luminescent members 30 is preliminarily inserted into an inner space of the inflated balloon 26.

The yo-yo balloon toy 15, 15A, 15B, 15C, 15D, 15E or 15F may be connected to an elastic cord such as a rubber or a spring at that one end.

When a user plays the yo-yo balloon toy, the user moves to shake the toy, up and down, or left and right by grasping another end of the elastic cord with the user's hand, thus visible light can be emitted from the balloon.

Twelfth Embodiment

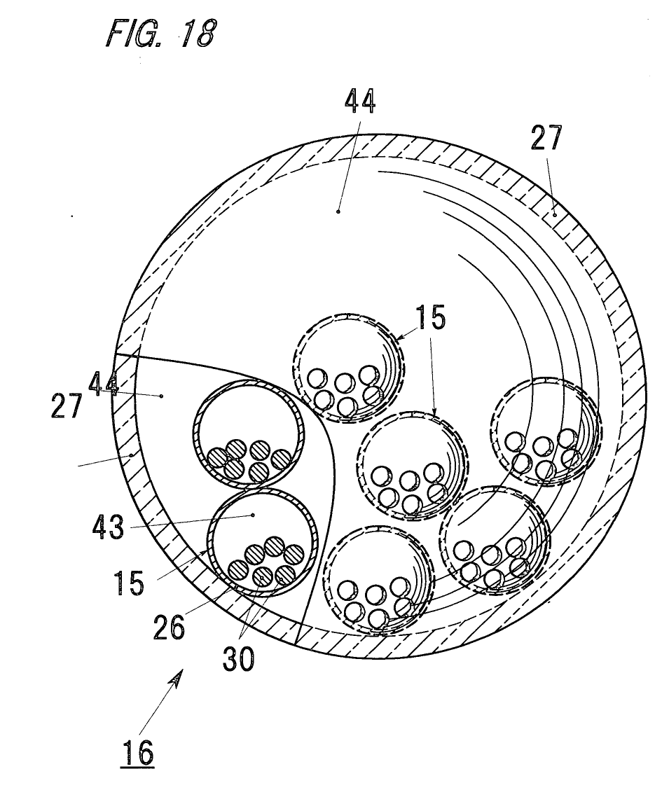

A twelfth embodiment of the present invention is explained with reference to FIG. 18.

A light emitting device of the twelfth embodiment of the present invention is an example of a duplex capsule-like stress light emitting device.

FIG. 18 is a schematic elevational view of a light emitting device of 12th embodiment of the present invention, in which a part of the light emitting device is shown as a cross section.

As shown in FIG. 18, a duplex capsule-like light emitting device 16 may be composed of a second shell (i.e. an outer capsule) 27 and one or more capsule-like light emitting device 15 having a first shell 26 movably enclosed in an inner space 44 of the second shell 27.

Further, the capsule-like light emitting device 15 may be composed of the first shell (i.e. capsule) 26 and one or more particulate stress luminescent cores 30 containing a stress luminescent material movably enclosed in an inner space 43 of the shell 26.

The second shell 27 may have the same material as that of the first shell 26 described hereinbefore.

The second shell 27 may contain a stress luminescent material disposed therein/thereon similar to the walls 20A, 20B, 20C and 20D described hereinbefore. Since the stress luminescent cores 30 movably enclosed in the first shell 26 may be composed of the same constitution as that of the particulate stress luminescent members 30, 30A, 30B, 30C and 30D described hereinbefore, the description of the stress luminescent cores 30 is omitted here.

Furthermore, one or more stirring (or agitating) members 27 (see FIG. 15) may be movably accommodated in the inner space 44 of the duplex capsule-like light emitting device 16.

Furthermore, one or more stirring (or agitating) members 27 (see FIG. 15) may be movably accommodated in the inner space 43 of the capsule-like light emitting device 15.

When an external mechanical force is applied to the duplex capsule-like light emitting device 16 receives, the capsule-like light emitting device/devices 15 move to make contact, friction and collision with the second shell 26 and some capsule-like light emitting device/devices 15 move to make contact, friction and collision with other capsule-like light emitting device/devices 15, thereby visible light is emitted therefrom.

Thirteenth Embodiment

A thirteenth embodiment of the present invention is another duplex capsule-like light emitting device.

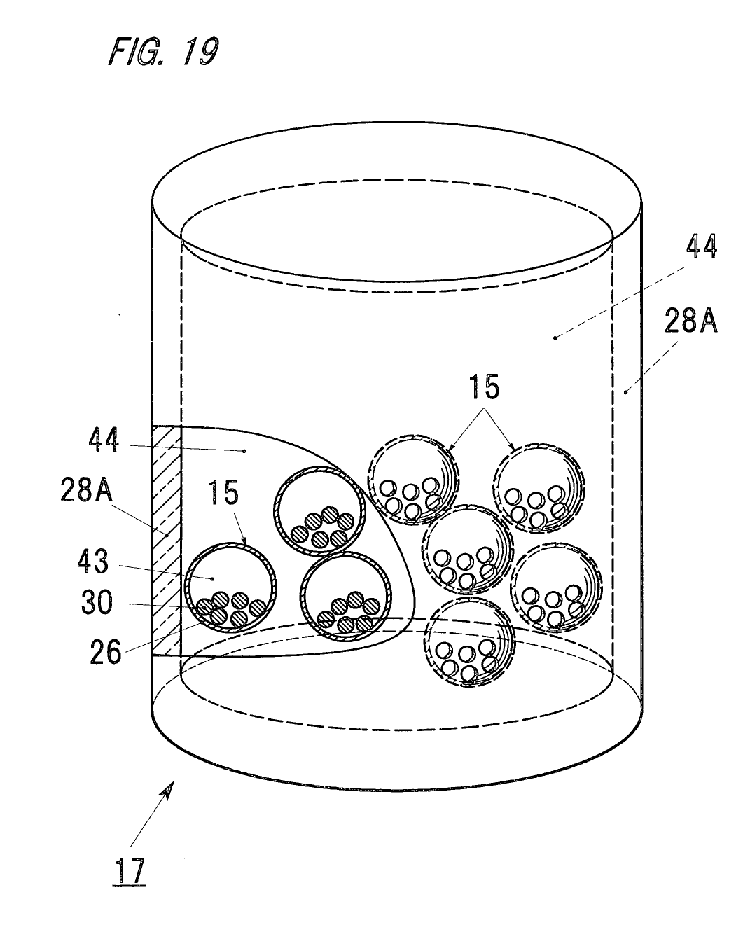

The thirteenth embodiment is explained with reference to FIG. 19.

FIG. 19 is a schematic perspective view of another light emitting device, in which showing a part of the light emitting device as a cross section.

As shown in FIG. 19, a duplex capsule-like light emitting device 17 may be composed of a second shell (i.e. an outer capsule) 28 having circular light permeable wall and one or more capsule-like light emitting device 15 having a first shell 26 movably enclosed in an inner space 44 of the second shell 28.

Further, the capsule-like light emitting device 15 may be composed of the first shell (i.e. capsule) 26 and one or more particulate stress luminescent cores 30 containing a stress luminescent material movably enclosed in an inner space 43 of the shell 26.

The duplex capsule-like light emitting device 16 having a spherical wall (see FIG. 18) or the duplex capsule-like light emitting device 17 having a cylindrical wall (see FIG. 19) may be fixed to any elongated member (not shown in FIG. 18 and FIG. 19) at that one end.

The elongated member may be composed of a rod-like, code-like or string-like member made of an elastic or non-elastic material.

An external mechanical force may be applied to the duplex capsule-like light emitting device 16 and 17 through another end of the elongated member as a fulcrum.

Fourteenth Embodiment

A fourteenth embodiment of the present invention is a modification of the capsule-like light emitting device 15 of the ninth embodiment referring to FIG. 15.

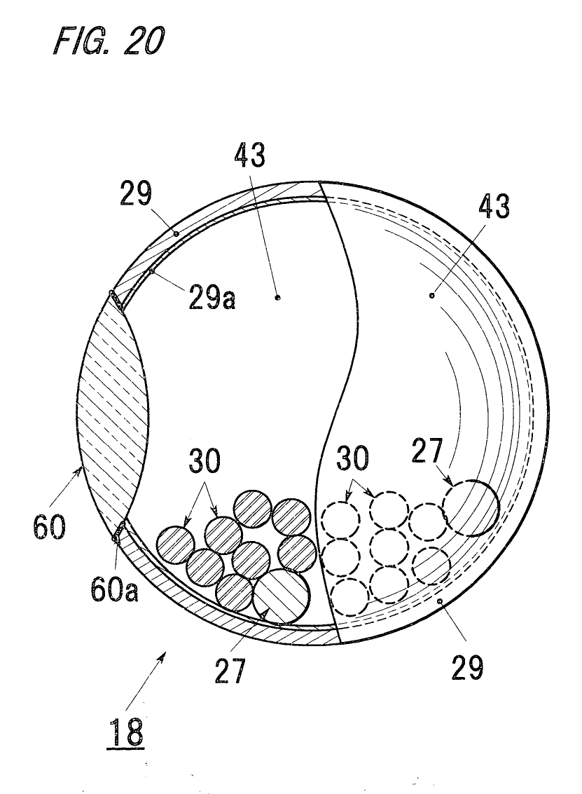

The fourteenth embodiment of the present invention is explained with reference to FIG. 20.

FIG. 20 is a schematic fragmentary sectional view showing a capsule-like light emitting device 18 showing a part as a cross section.

As shown in FIG. 20, the capsule-like light emitting device 18 may be composed of a shell (i.e. capsule) 29 having a spherical wall and a circular opening disposed in a part of the wall, a focus lens member 60 disposed in the opening and one or more stress luminescent cores or members 30 containing a stress luminescent material movably enclosed in an inner space or cavity 43 of the shell 29.

The lens member 60 is fixed to the shell 29 with such as an adhesive 61a near a circumference of the circular opening.

A light reflective film 29a is preferably provided on an inner wall of the shell 26, in which the light reflective film 29a may be made of metallic materials, such as aluminum, nickel, gold and silver.

In stead of the light reflective film 29a, a body of the shell 26 may be made of a light reflective material such as aluminum.

One or more stirring or agitating member 27 may be movably enclosed within the shell 29.

The focus lens member 60 may have a transparent hard coating such as a silica film or a transparent elastic coating such as such as a transparent silicone rubber film in an inner surface of the lens 60.

The focus member 60, in stead, the lens itself may be made of a transparent silicone rubber.

When an external force is applied to the capsule-like light emitting device 18 having the built-in lens 60, the stress luminescent cores 30 freely move within the inner space of the shell 29 so as to make contact, collision and friction with an inner surface of the shell wall 26 and some stress luminescent cores 30 make contact, collision and friction with other stress luminescent cores 30.

At that period, visible light is emitted from the stress luminescent cores 30 and the emitting light is focused at the lens 60 to exit outside the capsule-like light emitting device 18.

Fifteenth Embodiment

A fifteenth embodiment of the present invention is a modification of the capsule-like light emitting device 18 of the fourteenth embodiment referring to FIG. 20.

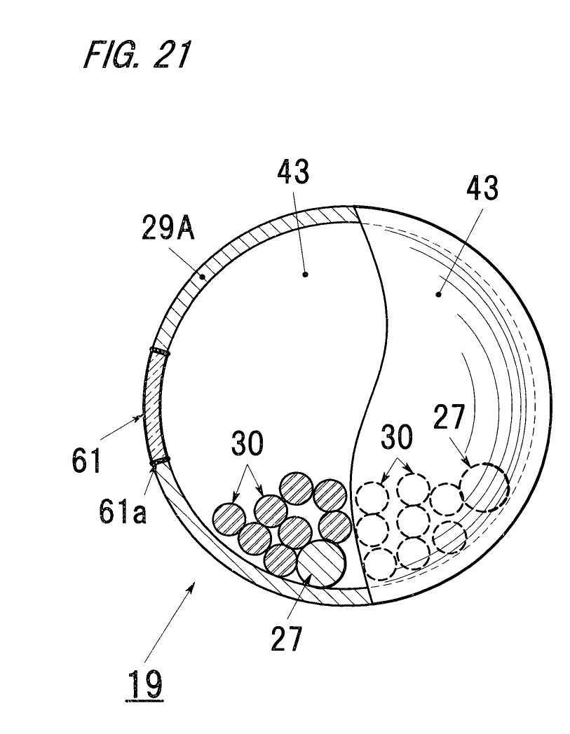

The fifteenth embodiment of the present invention is explained with reference to FIG. 21.

FIG. 21 is a schematic fragmentary sectional view showing a capsule-like light emitting device 19 showing a part as a cross section.

As shown in FIG. 21, the capsule-like light emitting device 19 may be composed of a shell (i.e. capsule) 29A having a spherical wall and a circular opening disposed in a part of the wall, a light permeable window 61 disposed in the opening and one or more stress luminescent cores or members 30 containing a stress luminescent material movably enclosed in an inner space or cavity 43 of the shell 29A.

The window 61 is fixed to the shell 61A with such as an adhesive 61a near a circumference of the circular opening.

When an external force is applied to the capsule-like light emitting device 19 having the built-in window 61, the stress luminescent cores 30 freely move within the inner space of the shell 29A so as to make contact, collision and friction with an inner surface of the shell wall 26 and some stress luminescent cores 30 make contact, collision and/or friction with other stress luminescent cores 30.

At that period, visible light is emitted from the stress luminescent cores 30 and the emitting light is exit outside the capsule-like light emitting device 19 through the window 61.

Sixteenth Embodiment

A sixteenth embodiment of the present invention is two examples applied to mechanical energy detecting devices.

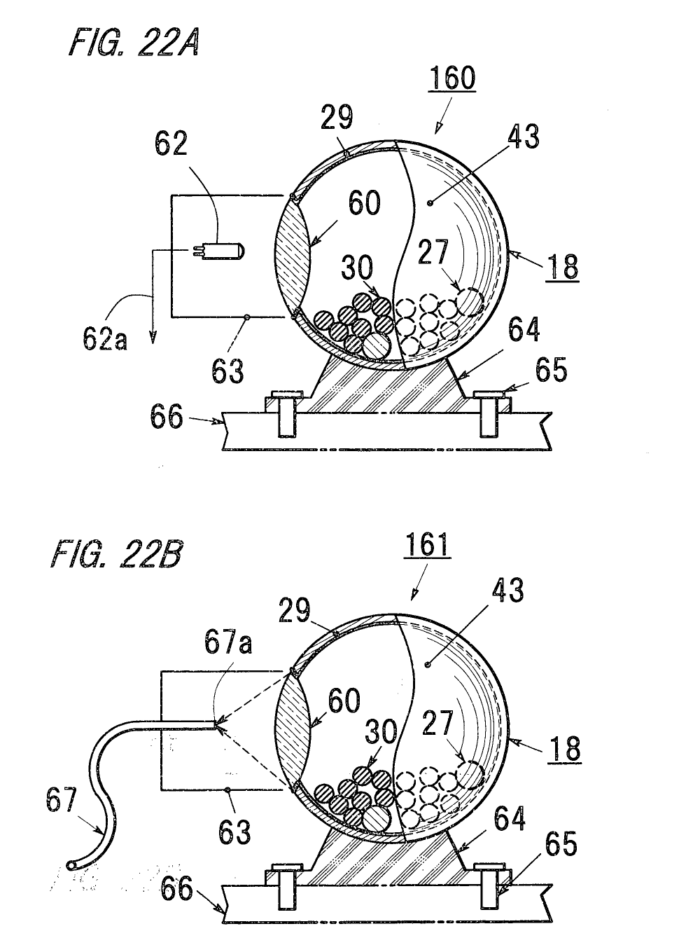

The mechanical energy detection devices of the sixteenth embodiment are explained with reference to FIG. 22A and FIG. 22B.

FIG. 22A is a schematic fragmentary sectional view of one mechanical energy detection device.

FIG. 22B is a schematic fragmentary sectional view of one mechanical energy detection device.

As shown in FIG. 22A and FIG. 22B, the mechanical energy detection devices 164 or 161 may be composed of a light emitting device 18 and a base 64 (support or bracket) fixed to the light emitting device 18.

The light emitting device 18 may be composed of a light shielded shell 29 with a lens 60, at least one particulate stress luminescent member 30 movably enclosed within the shell 29.

At least one weight or agitating member 27 (or a mass) may be movably enclosed within the shell 29, together with the stress luminescent member 30.

Furthermore, the mechanical energy detection devices 164 shown in FIG. 22A is composed of a photo-detector 62 such as a photo transistor, a photodiode and a CCD (Charge Coupled Device) disposed at a substantially focal point of the lens 60.

As shown in FIG. 22A, the semi-conductor photo-detector 62 may be covered with a light shield hood 63 to shield outside light and the photo-detector 62 is connected to an electrical circuit (not shown in FIG. 22A) positioned at a location far from the photo-detector 62 via electric-wires 62a.

The mechanical energy detection device 161 shown in FIG. 22B is further composed of an optical fiber 67 in which one end 67a of the optical fiber 67 is disposed at a substantially focal point of the lens 60, another end of the optical fiber 67 is disposed to face a photo-detector (not shown in FIG. 22B).

As shown in FIG. 22B, the optical fiber 67 may be covered near the one end with a light shield hood 63 to shield outside light and another end of the optical fiber 67 is optically connected to a photoelectric circuit (not shown in FIG. 22B) positioned at a location far from the one end of the optical fiber 67, in which the photoelectric circuit includes a photo-detector and an electrical circuit.

The stress light emitting device 18 is fixed to any bodies 66 at the base 64, such as an automobile, a building and a structure, by fixed means such as a screw 65.

These mechanical energy detection device 164 and 161 can be used in such as an acceleration sensor, a deceleration sensor, an impact sensor, a collision sensor and an earthquake sensor.

For one example, the mechanical energy detector 164 and 161 can be used as an impact or collision sensor.

If the impact or collision sensor 164 or 161 is fixed to a body of an automobile, the stress luminescent device 18 emits light when the automobile device strong mechanical impact due to collision with other automobile.

That light from the stress luminescent device 18 is received at the photo-detector 62 or the optical fiber 67 (and an opt-electric circuit) and an electric signal inputs an airbag control circuit to inflate an air bag or a seat belt control circuit to tighten a seat belt.

Seventeenth Embodiment

A seventeenth embodiment of the present invention is two examples applied to mechanical energy detecting devices.

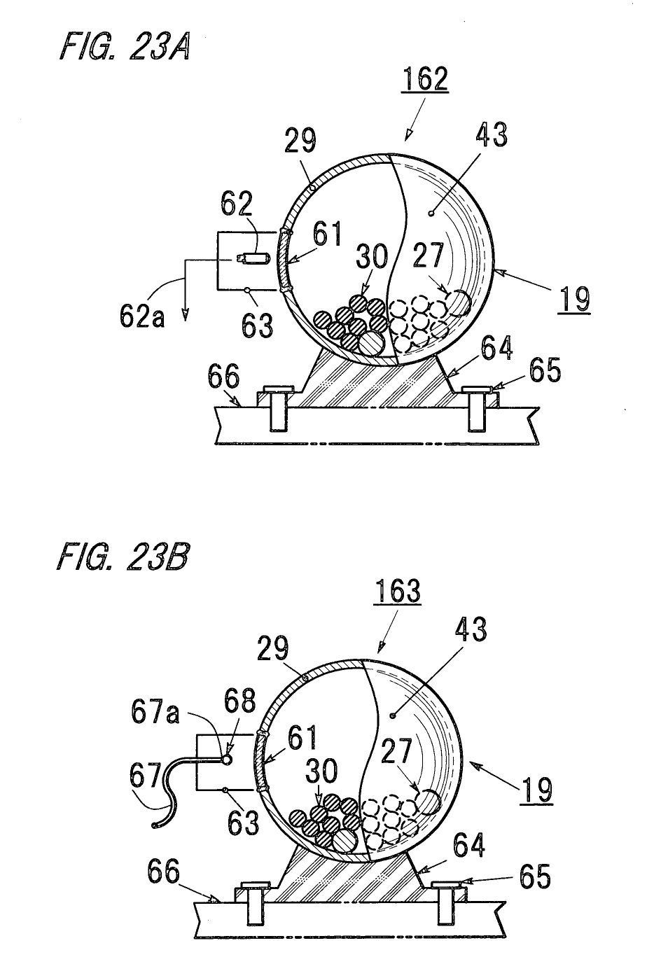

The mechanical energy detection devices of the seventeenth embodiment are explained with reference to FIG. 23A and FIG. 23B.

FIG. 23A is a schematic fragmentary sectional view of one mechanical energy detection device.

FIG. 23B is a schematic fragmentary sectional view of one mechanical energy detection device.

As shown in FIG. 23A and FIG. 23B, the mechanical energy detection devices 162 or 163 may be composed of a light emitting device 19 and a base (support or bracket) 64 fixed to the light emitting device 18.

The light emitting device 19 may be composed of a light shielded shell 29 with a light permeable window 61, at least one particulate stress luminescent member 30 movably enclosed within the shell 29.

Optionally, at least one particulate agitating member 27 (or a mass or weight) movably enclosed within the shell 29, together with the stress luminescent member 30.

Furthermore, the mechanical energy detection devices 162 shown in FIG. 23A is composed of a photo-detector 62 such as a photo transistor, a photodiode and a CCD (Charge Coupled Device) disposed to face the window 61.

As shown in FIG. 23A, the semi-conductor photo-detector 62 may be covered with a light shield hood 63 to shield outside light and the photo-detector 62 is connected to an electrical circuit (not shown in FIG. 23A) positioned at a location far from the photo-detector 62 via electric-wires 62a.

The mechanical energy detection device 163 shown in FIG. 23B is further composed of an optical fiber 67 in which one end 67a of the optical fiber 67 is disposed to face the window 61 and another end of the optical fiber 67 is disposed to face a photo-detector (not shown in FIG. 23B).

As shown in FIG. 23B, the optical fiber 67 may be covered near the one end with a light shield hood 63 to shield outside light and another end of the optical fiber 67 is optically connected to a photoelectric circuit (not shown in FIG. 23B) positioned at a location far from the one end of the optical fiber 67, in which the photoelectric circuit includes a photo-detector and an electrical circuit.

These mechanical energy detection device 162 and 163 can be used in such as an acceleration sensor, a deceleration sensor, an impact sensor, a collision sensor and an earthquake sensor.

For one example, the mechanical energy detector 162 and 163 can be used as an impact or collision sensor for use in automobiles.

If the impact or collision sensor 162 or 163 is fixed to a body of an automobile, the stress luminescent device 19 emits light when the automobile device strong mechanical impact due to collision with other automobile.

That light from the stress luminescent device 19 is received at the photo-detector 62 or the optical fiber 67 (and an opt-electric circuit) and an electric signal inputs an airbag control circuit to inflate an air bag or a seat belt control circuit to tighten a seat belt.

Eighteenth Embodiment

An eighteenth embodiment of the present invention is two examples applied to mechanical energy detecting devices.

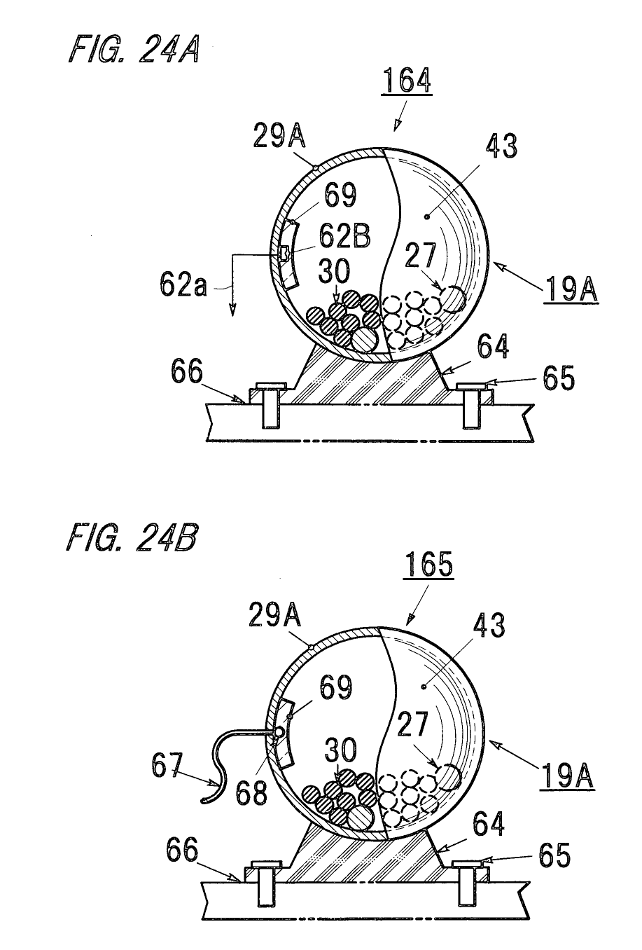

The mechanical energy detection devices of the eighteenth embodiment are explained with reference to FIG. 24A and FIG. 24B.

FIG. 24A is a schematic fragmentary sectional view of one mechanical energy detection device.

FIG. 24B is a schematic fragmentary sectional view of one mechanical energy detection device.

As shown in FIG. 24A and FIG. 24B, the mechanical energy detection devices 164 or 165 may be composed of a light emitting device 19A and a base (or support or bracket) 64 fixed to the light emitting device 19A.

The light emitting device 19A may be composed of a light shielded shell 29A, at least one particulate stress luminescent member 30 movably enclosed within the shell 29A.

Optionally, at least one particulate agitating member 27 (or a mass or weight) movably enclosed within the shell 29A, together with the stress luminescent member 30.

In the mechanical energy detection device 164 shown in FIG. 24A, a small photo-detector 62B may be disposed on an inner surface of the light shielded shell 29A.

The photo-detector 62B may be fixed to the inner surface using a transparent member 69 e.g. a transparent adhesive made of silicone resin or epoxy resin. The small photo-detector 62B may be selected from a chip-sized phototransistor, photodiode or CCD.

The photo-detector 62B is connected to an electric circuit far from the photo-detector 62B via electric wires 62a.

In the mechanical energy detection device 165 shown in FIG. 24B, a proximate end 67a of an optical fiber 67 may be disposed at an inner surface of the light shielded shell 29A.

A lens (or lens portion) 68 may be provided at or near the proximate end 67a of the optical fiber 67.

The proximate end 67a and the lens 68 may be fixed to the inner surface using a transparent member 69 e.g. a transparent adhesive made of silicone resin or epoxy resin.

The distal end of the optical fiber 67 may be disposed to face a photo-detector in an opt-electric circuit (not shown in FIG. 24B) far from the proximate end 67a of the optical fiber 67.

These mechanical energy detection device 164 and 165 can be used in such as an acceleration sensor, a deceleration sensor, an impact sensor, a collision sensor and an earthquake sensor.

For one example, the mechanical energy detector 164 and 165 can be used as an impact or collision sensor for use in automobiles.

If the impact or collision sensor 164 or 165 is fixed to a body of an automobile, the stress luminescent device 19A emits light when the automobile device strong mechanical impact due to collision with other automobile.

That light from the stress luminescent device 19A is received at the photo-detector 62 or the optical fiber 67 (and an opt-electric circuit) and an electric signal therefrom inputs an airbag control circuit to inflate an air bag or a seat belt control circuit to tighten a seat belt.

Nineteenth Embodiment

The ninteenth embodiment of the present invention is one application which enables to emit light from artificial eyeballs in e.g. a doll, an animal toy and a robot imitating human beings and animals, in which the eyeballs capable of emitting light give a new charm and attractiveness to people.

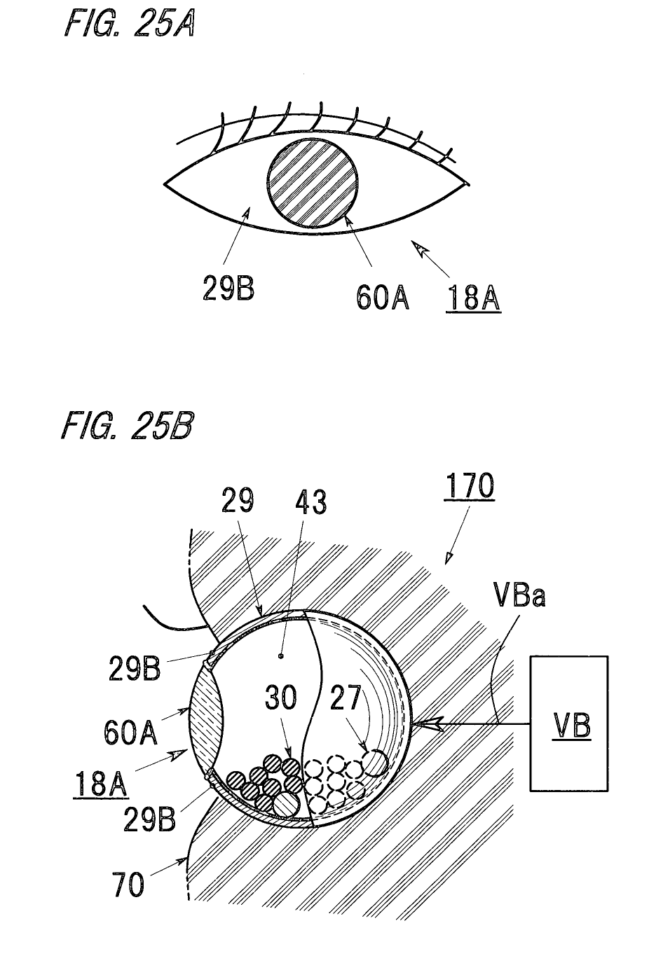

FIG. 25A is an explanatory view of a ninteenth embodiment showing an artificial eye of e.g. a doll 170.

FIG. 25B is a schematic fragmentary sectional view of the artificial eye shown in FIG. 25A.

In this embodiment, the stress light emitting device 18A shown in FIG. 20 is applied to an artificial eye or eyeballs of a doll.

As shown in FIG. 25A and FIG. 25B, an artificial doll 170 may include artificial eyes 18A positioned in a face 70, in which a stress light emitting device 18A corresponds to each eye or eye ball 18A.

The stress light emitting device 18A (i.e. an artificial eye) may be roughly composed of a spherical wall 29, a convex lens 60A (i.e. a pupil portion) and an exposed portion 29B (i.e. a pewter portion) of the wall 29.

The spherical wall 29 may be composed of light shielded spherical member having e.g. a light reflective inner surface.

The convex lens 60A may be composed of light permeable member made of transparent material or transparent material with color die or pigments.

The spherical wall 29 may have the exposed portion 29B with a white coating on an outer surface on the exposed portion 29B.

A plurality of particulate stress luminescent members 30 and optionally at least one particulate agitating member 27 are movably accommodated in an inner cavity or space 43 within the spherical wall 29.

The stress light emitting device 18A (i.e. an artificial eye) may be in a vibration coupling “VBa” with any vibrator “VB” such as a piezo-electric vibrator and a vibration motor.

The stress light emitting device 18A emits light from the stress luminescent members 30, when the doll 70 is shaken by manual operation, a mechanical vibration is given to the stress light emitting devicel8A by operating the vibrator “VB”.

The emission of light is passes through the convex lens member 60A and observers can see the eye of the doll 70 emitting light.

Twentieth Embodiment

A twentieth embodiment of the present invention is some applications of a light emitting device for use in a field of ornaments or accessories, such as an earring, a necklace and a pendant.

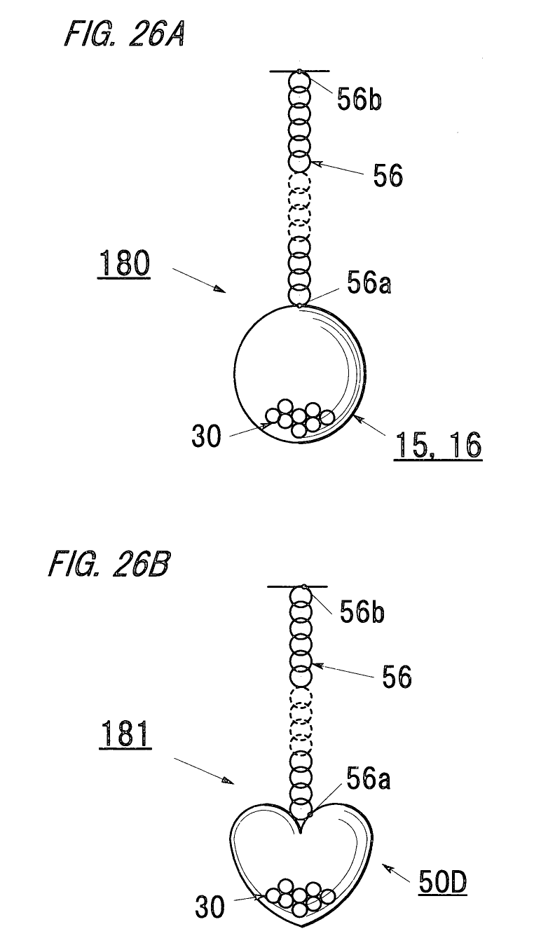

A twentieth embodiment is explained with reference to FIG. 26A and FIG. 26B.

FIG. 26A and FIG. 26B are schematic elevational views showing examples of ornaments or accessories.

As shown in FIG. 26A, an ornament or accessory 180 may include the light emitting device 15 or 16 described hereinbefore referring to FIG. 15 and FIG. 18. necklace

As shown in FIG. 26B, an ornament or accessory 181 may include the light emitting device 15D, 15E and 15E described hereinbefore referring to FIG. 17A, FIG. 17B and FIG. 17C respectively.

The ornament or accessory 180 shown in FIG. 26A is composed of the light emitting device 15 or 16 and a hanging member 56 to fix the light emitting device 15 or 16 at an end 56a, in which the hanging member 56 may be a chain, a string, a band, a rubber cord and a spring.

The light emitting device 15 or 16 is composed of a spherical or disk having a cavity therein and stress luminescent particles 30 in the cavity.

The ornament or accessory 181 shown in FIG. 26B is composed of the light emitting device 15D, 15E and 15E, 15E and 15E and a hanging member 56 to support the light emitting device, in which the hanging member 56 may be a chain, a string, a band, a rubber cord and a spring.

The light emitting device 15 or 16 is composed of a heart-shaped member having a cavity therein and stress luminescent particles 30 in the cavity.

The ornaments or accessories 180 and 181 such as such as an earring, a necklace and a pendant may be fixed or worn on a human body or clothes at another end 56b of the hanging member 56.

During walking or running of a person, the light emitting devices e.g. 15 and 50D are subjected to move, swing or shake to make the end 56b of the hanging member 56 as the fulcrum.

Therefore, the ornaments or accessories 180 and 181 emit visible light from the stress luminescent particles 30 of the light emitting devices e.g. 15, 16 and 50D when receive a mechanical energy.

The hanging ornaments or accessories 180 and 181 shown in FIG. 26A and FIG. 26 B are not limited to the accessories, but can be used as toys e.g. yo-yo toys which emit light by swaying, swinging or shaking manually.

The hanging ornaments or accessories 180 and 181 can be used as other ornamental articles which emit light by swaying, swinging or shaking by a natural wind or an artificial wind from a folding or an electric fan.

The hanging ornaments or accessories 180 and 181 can generate similar sound to the sound of a bell, a wind-chime, etc. while emitting light, when swaying, swinging or shaking.

The stress luminescent devices e.g. 15, 16 and 50D may have any configurations such as the shapes of the light emitting devices 15A (see FIG. 16A), 15B (see FIG. 16B), 15C (see FIG. 16C), 15E (see FIG. 17B), and 15F (see FIG. 17C), as well as the spherical shape 15, 16 and the heart-like shape 15D.

These stress luminescent devices e.g. 15, 16 and 50D may be used as the accessories of other types such as a necktie pin, a broach, a bracelet and a ring, so that they can flash light on and off, during the movement of a human body, such as walking, running and jumping.

Twenty First Embodiment

A twenty first embodiment is applications of the aforementioned stress luminescent devises to balloons capable of floating the air.

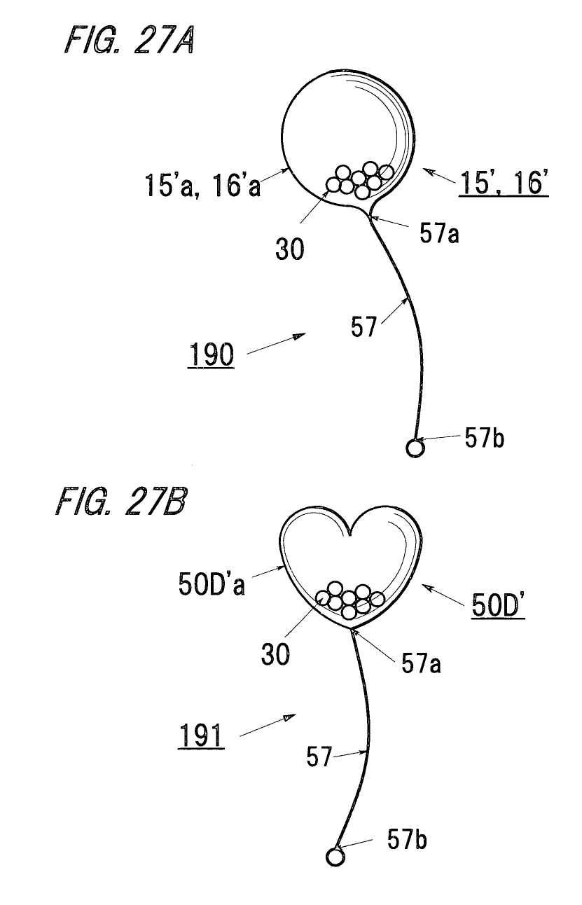

A twenty first embodiment is explained referring to FIG. 27A and FIG. 27B. FIG. 27A and FIG. 27B are schematic elevational views showing balloons 190 and 191 respectively.

As shown in FIG. 27A a ballon 190 may includes a lighted balloon 15′ or 16′ having the same configuration as that of the stress luminescent devices 15 and 16 shown in FIG. 15 and FIG. 16.

The lighted balloon 15′ or 16′ is composed of a light permeable shell made of an elastic membrane to form a spherical shape when the shell is filled with and inflated by light gas such as helium and stress luminescent particles 30 preliminarily inserted within the shell.

If a total weight of the lighted balloon 15′ or 16′ is lighter than air, the lighted balloon 15′ or 16′ can float in the air.

The lighted balloon 15′ and 16′ may be fixed to a string-like member 57 at one end 57a and the string-like member 57 is fixed with people's hand or any body at another end 57b.

As shown in FIG. 27B, a balloon 191 may include a lighted balloon 50D′ having the same configuration as that of the stress luminescent devices 50D shown in FIG. 17A.

The lighted balloon 50D′ is composed of a light permeable shell made of an elastic membrane to form a heart-like shape when the shell is filled with and inflated by light gas such as helium and stress luminescent particles 30 preliminarily inserted within the shell.

If a total weight of the lighted balloon 50D′ is lighter than air, the lighted balloon 50D′ can float in the air.

The lighted balloon 50D′ may be fixed to a string-like member 57 at one end 57a and the string-like member 57 is fixed with people's hand or any body at another end 57b.

When swaying, swinging or shaking by the wind, these balloons 190 and 191 can emit visible light from the lighted balloons 15′, 16′ and 50D, since the stress luminescent particles 30 receives a mechanical energy due to contact, impact, friction and collision with an inner surface of the lighted balloons 15′, 16′ and 50D and/or with other stress luminescent particles 30.

The lighted balloon 15′, 16′ and 50D′ may have any configuration similar to that of the light emitting devices shown in FIG. 16A, FIG. 16B, FIG. 16C, FIG. 17A, FIG. 17B and FIG. 17C as well as the 15′, 16′ and 50D′.

Twenty Second Embodiment

A twenty second embodiment of the invention is an application of the aforementioned light emitting devices to an artificial plant such as an artificial flower capable of emitting light.

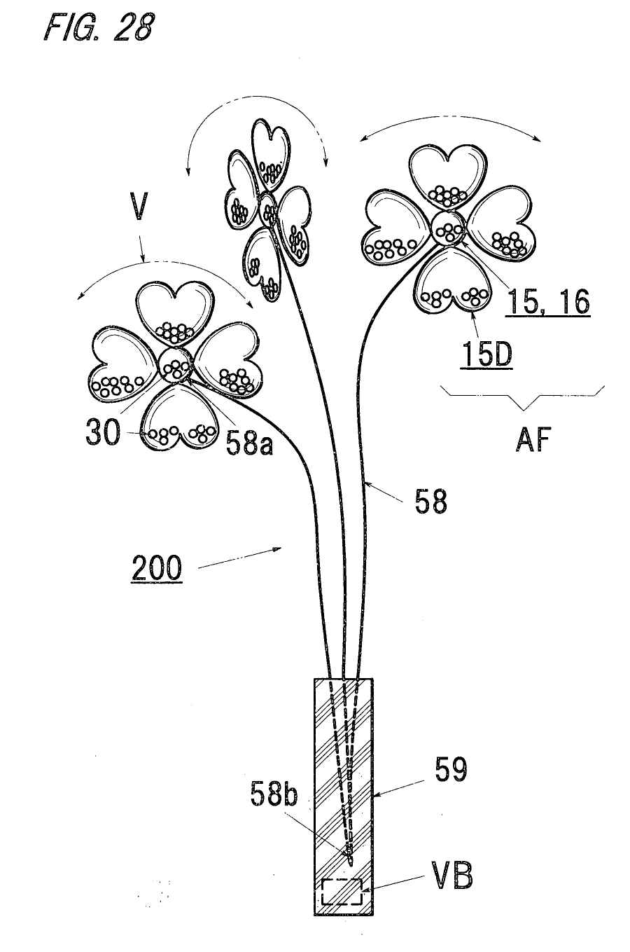

A twenty second embodiment is explained referring to FIG. 28.

FIG. 28 is a schematic elevational view showing an artificial flower device according to the twenty second embodiment.

As shown in FIG. 28, an artificial flower device 200 is composed of one or more artificial flowers “AF”, one or more supporting wires 58 made of flexible or elastic material to fix the artificial flowers “AF” at one end 58a and a grip member 59 for a person to grip to be fixed to another end 58b of the supporting wires 58.

The artificial flowers “AF” is composed of any combination of the before mentioned spherical stress luminescent devises, such as a combination composed of the spherical stress luminescent devises 15 and 16 shown in FIG. 15 and FIG. 18 and the heart-like stress luminescent devises 15D shown in FIG. 17A.

The artificial flowers “AF” to be formed from the stress luminescent devises 15, 16 and 15D may be composed of light permeable shells (or envelopes) having cavities therein and stress luminescent particles movably accommodated in the cavity.

A vibrator “VB” such as a piezo-electric vibrator or a vibrating motor is optionally provided in an interior of the grip member 59, in which the vibrator “VB” makes a vibrating connection to the anther end 58b of the supporting wire 58.

If the grip member 59 is grasped by a hand and the supporting wire 58 is moved to swing, sway or shake right and left or rotated manually, a mechanical force such as vibration is transmitted from another end 68b of the supporting wire 58 to the one end 68a and the artificial flowers “AF”, in which the another end 68b is acting as the fulcrum of that movement.

In stead of the abovementioned manual movement, the vibrator “VB” may be used to generate vibration which is transmitted to the artificial flower “AF” through the supporting wire 58.

During these movements, the artificial flower “AF” formed from the light emitting devices 15, 18 and 15D emits visible light since the stress luminescent particles 30 receives the mechanical energy due to contact, impact, friction and collision with an inner surface of the light emitting devices 15, 18 and 15D and/or with other stress luminescent particles 30.

The artificial flower “AF” can generate the same sound as a bell, a wind-chime, etc. during emitting light when the movement is given to the artificial flower “AF”.

The artificial flower “AF” may have any configuration formed from any combination of the light emitting devices with the same or different shapes shown in e.g. FIG. 16A, FIG. 16, FIG. 16C, FIG. 17A, FIG. 17B and FIG. 17C.

Twenty Third Embodiment

A twenty third embodiment of the invention is a dynamic exhibition device (i.e. a kinetic display device) using the before-mentioned hanging light emitting devices.

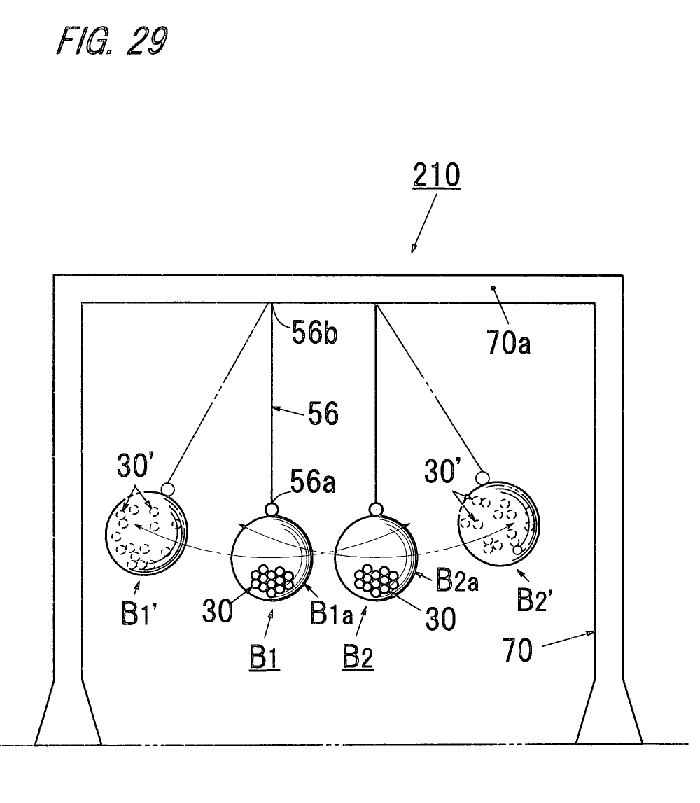

The dynamic exhibition device according to the twenty third embodiment of the invention is explained with reference to FIG. 29.

FIG. 29 is a schematic elevational view showing the dynamic exhibition device.

As shown in FIG. 29, the dynamic exhibition device 210 may be composed of at least two light emitting balls B1 and B2, a bridge type prop 70 and at least two string members 56.

The at least two light emitting balls B1 and B2 may be composed of the same constitution as that of the at least two spherical stress emitting devices 15 or 16 shown in FIG. 15 and FIG. 18.

The light emitting balls B1 and B2 may be composed of light permeable spherical shells B1a and B2a respectively and stress luminescent particles 30 are movably disposed within the shells B1a and B2a.

The bridge type prop 70 may be composed of two vertical poles and a horizontal rod 70a disposed on top ends of the two vertical poles 70.

The light emitting balls B1 and B2, each ball is fixed to one end of each string member 56 and another end of the each string member 56 is foxed to the horizontal rod 70a of the bridge type prop 70.

The at least two light emitting balls B1 and B2 are hung by the at least two string members 56 on different positions of the horizontal rod 70a.

The two string members 56 have the same length so that the two light emitting balls B1 and B2 face together horizontally in a static sate.

For example, if the light emitting ball B1 is moved to lift from that original position to the position of a virtual ball B1′ by a hand and then the hand is separated from the light emitting ball B1, the ball B1 drops or descends with gravity as the fulcrum in the top ends 56b of the string member 56 and the ball B1 reaches or passes the original position to collide with the another ball B2 in a static state.

At that time, the one ball B1 having a kinetic energy is transferred to another ball B2 and the one ball B1 stops in the original position.

After the another ball B2 receives the kinetic energy from the one ball B1, the ball B2 moves to lift up to the another position of another virtual ball B1′, and then the another ball B2 drops or descends with a gravity and reaches or passes the original position to collide with the one ball B1 in a static state.

The above kinetic or dynamic movement of two balls B1 and B2 is repeated many times and two balls B1 and B2 stop after predetermined time and remain at the original position or in the static state.

Instead of the above, if the light emitting ball B1 and B2 are moved simultaneously to lift from that the original positions to the positions of a virtual balls B1′ and B2′ by hands, and then the hands are separated from the light emitting balls B1 and B2, the balls B1 and B2 drop or descend with gravity as the fulcrum in the top ends 56b of the string members 56 and the ball B1 and B2 strike or collide to each other.

When the ball B1 and B2 strike or collide together, the ball B1 and B2 react to lift up and drops with the gravity to collide together again and the ball B1 and B2 lift again by that reaction.

The ball B1 and B2 stop at the original positions after the movement is repeated multiple times.

As shown in FIG. 29, when the light emitting balls B1 and B2 are in static state, the stress luminescent particles 30 are positioned near each bottom of the shells B1a and B2a.

On the other hand, when the balls B1′ and B2′ are in moving state, the stress luminescent particles 30′ are scattered at random within the shells due to a collision of the balls B1 and B2.

Thus, in the dynamic exhibition or display device 210, due to a collision of the balls B1 and B2, since the stress luminescent particles 30′ within the balls B1′ and B2′ strike or collide together and also the stress luminescent particles 30′ strike or collide with each inner surface of the balls B1′ and B2′.

Therefore, the lighted balls B1, /B1′ and B2/B2′ emit light and sound for predetermined time, so that a user/users can admire to see and hear the light and the sound induced by the collision or striking of the balls.

Twenty Fourth Embodiment

A twenty fourth embodiment is an application of the stress luminescent elements to a water fall display device.

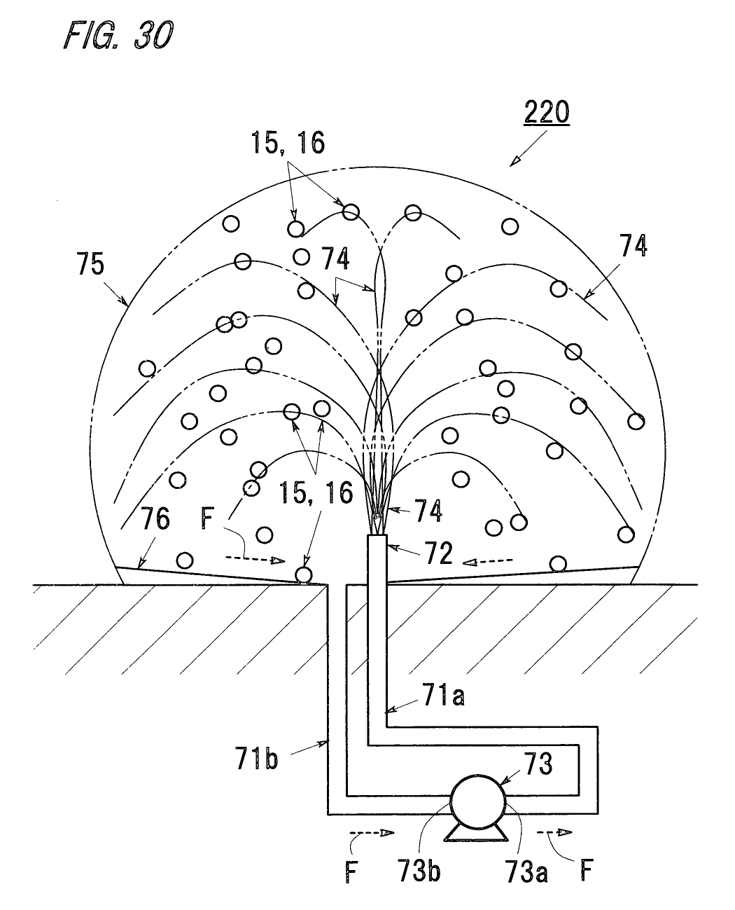

A water fall display according to the twenty fourth embodiment is explained with reference to FIG. 30.

FIG. 30 is a schematic elevational view showing the water fall display device.

As shown in FIG. 30, a fountain display device 220 may be composed of a circulating pump 73, at least one fountain nozzle 72, a water supplying pipe 71a, a water collecting pipe 71b and a plurality of light emitting elements (devices) 15 (see FIG. 15) and/or 16 (see FIG. 18) disposed within water 74.

It is noted that the light emitting elements 15 and/or 16 may be replaced with the light emitting elements 30 (30A, 30B, 30C and 30D) (see FIG. 4A, FIG. 4A, FIG. 4B, FIG. 5A and FIG. 5B).

It is noted that the fountain display device 220 is act as a liquid supply device or a water or liquid flow generator to give a mechanical energy to the light emitting elements 15 and/or 16 which includes a stress luminescent material.

The circulating pump 73 is connected to an end of the water supplying pipe 71a at a water supply hole 73a and it is connected to an end of the water collecting pipe 71b at a water collecting-hole 73b to supply the water 74 to the pump 73.

The fountain nozzle 72 is positioned at a top of the water supplying pipe 71a to sending out upwardly the pressurized water 74 containing the light emitting elements 15 or 16 mixed therein.

The water 74 having the light emitting elements 15 or 16 flows in the water supply hole 73a, the water supplying pipe 71a, the fountain nozzle 72, an exterior space, the water collecting pipe 71b, the water collecting hole 73b and the circulating pump 73, so that a circulating flow “F” of the water 74 is produced.

The light emitting elements 15 or 16 may have a substantially spherical capsule-like member having an outer diameter less than a nozzle diameter of the fountain nozzle 72.

For example, the capsule-like light emitting elements 15 or 16 for use in the large or medium scale fountain displays devices may have the size and weight similar to that of the balls such as ping pong balls, golf balls, baseball balls and table tennis balls. However, the capsule-like light emitting elements 15 or 16 for use in the smaller scale fountain displays devices such as a desk-top ornamental fountain display may have the smaller size and weight that are determined according to the scale.

In stead of the light emitting elements 15 or 16, the light emitting elements (devices) 15A (see FIG. 16A), 15B (see FIG. 16B), 15C (see FIG. 16C), 15D (see FIG. 17A), 15E ((see FIG. 17B) and 15F (see FIG. 17C) may be used.

A transparent dome or semicircle sphere 75 for covering the fountain may be provided for covering the fountain, so that all of the water 74 and the light emitting elements 15 or 16 can be collected and circulated.

The water 74 and the light emitting elements 15 and/or 16 are ejected upwardly from the fountain nozzle 72c to the exterior space, rise radially and then fall or descend radially.

The water 74 and the stress light emitting devices 15 and 16 which fall naturally go into the water collecting 71b preferably via an inclined plane 76 and return to the water supply-hole 73b of the circulating pump 73.

While the water and the light emitting elements 15 and/or 16 moves upwardly or downwardly, the light emitting elements receives a mechanical energy, since the light emitting elements 15 and/or 16 move and scatter to strike and collide repeatedly with the water and/or the other light emitting elements 15 and/or 16.

Therefore, the stress luminescent particles movable accommodated within the light emitting elements 15 and/or 16 move and scatter at random to strike and collide with other stress luminescent particles and/or the inner walls of the light emitting elements 15 and/or 16 to emit visible light with a comparatively strong brightness.

If the light permeable dome or semi-sphere cover 75 without or with stress luminescent material for covering the display is provided, the light emitting elements 15 emit light with more strong brightness, since the light emitting elements 15 receives a mechanical energy from the cover 75 due to the striking or collision with the light emitting elements 15 and an inner surface of the cover 75.

People look the display 220 especially at a dark place or at night, as if a firework or many fireflies (fire bugs) flashes luminescence at random.

In the fountain display, the water and the light emitting elements are circulated by the same circulating system so as to eject from the same fountain nozzle, but the circulating system may be separated to two circulating systems in which one circulating system is used only for the water and another circulating system is used only for the light emitting elements.

In this case, the nozzle ejecting the water is preferably positioned near an additional nozzle ejecting the light emitting elements so as to mix together when both the water and the light emitting elements are ejected to an exterior air space.

Furthermore, a dynamic display using only the light emitting elements may be replaced with the fountain display the water and the light emitting elements together described above.

The dynamic display using only the light emitting elements 15 and/or 16 may be composed of a similar constitution to the fountain display 220 shown in FIG. 30, in which air or compressed air is used instead of the water 74 and the water circulating pump is replaced with an air circulating pump.

Therefore, the air or compressed air including the light emitting elements 15 and/or 16 is ejected and ascended upwardly from an air nozzle to the exterior air space and the light emitting elements 15 and/or 16 descended downwardly is collected to repeat for a circulation of the light emitting elements 15 and/or 16 through the air pipes 71a and 71b and the air circulating pump.

Twenty Fifth Embodiment

A twenty fifth embodiment is a dynamic lighted ornamental display using the light emitting devices.

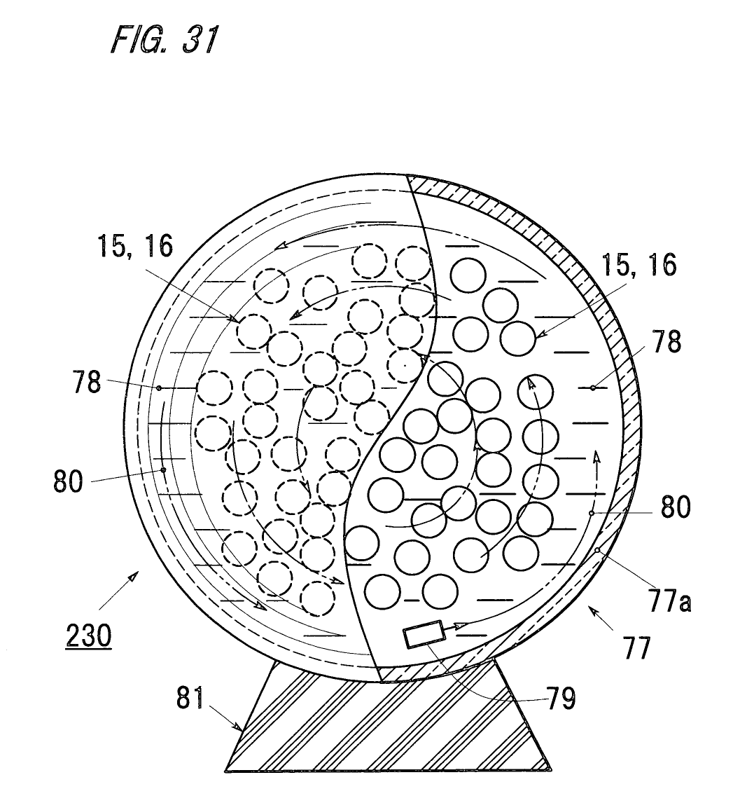

The twenty fifth embodiment is explained with reference to FIG. 31.

FIG. 31 is a schematic elevational view showing the dynamic lighted ornamental display, a part of which is shown as a cross section.

As shown in FIG. 31, the dynamic lighted display 230 may be composed of a container 77 having a light permeable wall 77a, a light permeable liquid 78 filled in an inner space within the wall 77a, stress luminescent elements 15 and/or 16 disposed in the liquid 78 and a vibrator 79.

It is noted that the light emitting elements 15 and/or 16 may be replaced with the light emitting elements 30 (30A, 30B, 30C and 30D) (see FIG. 4A, FIG. 4A, FIG. 4B, FIG. 5A and FIG. 5B).

The container 77 has a spherical or circular outer shaped configuration and it is supported by a base member 81.

The vibrator 79 may be disposed at a predetermined location of the space or the wall 77a in such a manner that a vibrating head of the vibrator 79 has one directional angle so that the light permeable liquid 78 is rotated and circulated by the directional angle within the container 77.

The stress luminescent elements 15 and 16 are described in the above referring to FIG. 15 and FIG. 18, therefore the description of which is omitted here. In stead of the stress luminescent elements 15 and 16, the stress luminescent elements or devices 15A (see FIG. 16A), 15B (see FIG. 16B), 15C ((see FIG. 16C), 15D (see FIG. 17A), 15E (see FIG. 17B) and 15F (see FIG. 17C) may be used.

When the vibrator 79 is driven, the light permeable liquid 78 makes a rotating movement 80 repeatedly to a fixed direction within the spherical or circular shell wall 77a so that the stress luminescent elements 15 and/or 16 move to circulate to the fixed direction within the shell wall 77a corresponding to the rotating movement 80 of the liquid 78.

The vibrator 79 may be composed of a mechanical vibrator, an electromagnetic vibrator, a piezo-electric vibrator, a vibration motor or a speaker.

The vibrator 79 generates a mechanical vibration, an acoustic vibration i.e. sound or an ultrasonic vibration.

If the vibrator 79 is a piezo-electric device generating the ultrasonic vibration forming air bubbles i.e. air pockets in the liquid 78 and then the air bubbles are destructed to produce an impact pressure or shock wave.

It is noted that the vibrator 79 generating the ultrasonic vibration is acting as an air bubble generator to give a mechanical energy to the above mentioned light emitting device or the above mentioned stress luminescent material.

When the stress emitting elements 15 and/or 16 receive the impact pressure i.e. shock wave transmitted through the liquid 78, thereby the liquid 78 and the stress emitting elements 15 perform a random movement.

The air bubbles acts as light diffusers, due to the difference of refractive index between the air bubbles and the liquid 78.

Due to the above rotating movement 80 of the liquid 78 and the above random movement induced by the cavitation, the stress emitting elements 15 and/or 16 repeatedly collide with other stress emitting elements 15 and/or 16 and with an inner surface of the shell wall 77a.

Then, the stress luminescent particles movably enclosed in the stress emitting elements 15 and/or 16 repeatedly move to make a collision and/or a friction with other stress luminescent particles and with an inner wall of the stress emitting elements 15.

Therefore, the light emitting elements 15 and 16 emit flashing light on and off with stronger brightness, the light is scattered by the air bubbles acting as the diffusers and the scattered light exits at a wide-angle to an exterior of the container 77.

Twenty Sixth Embodiment

The twenty sixth embodiment of the present invention is another dynamic lighted ornamental display using the light emitting devices.

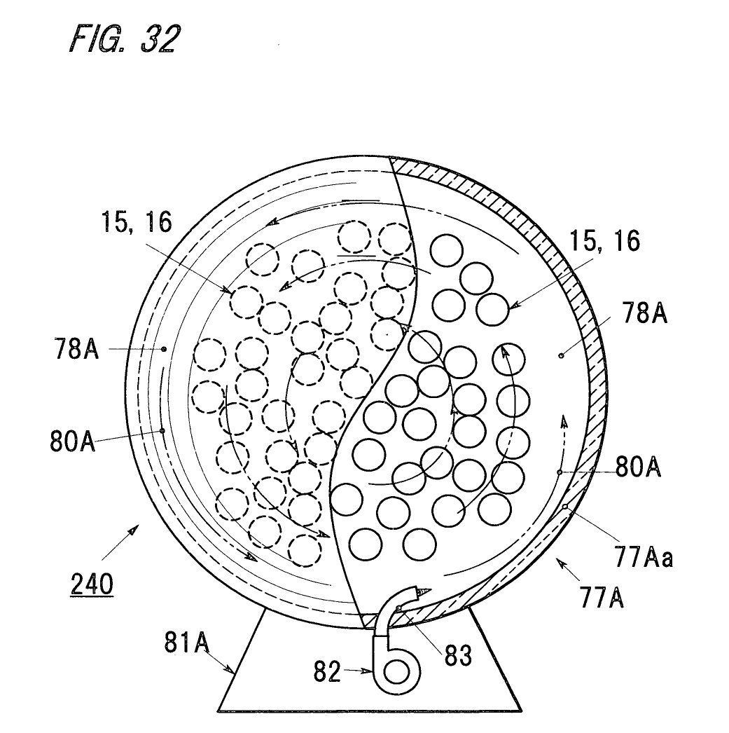

The twenty sixth embodiment is explained with reference to FIG. 32.

FIG. 32 is a schematic fragmentary elevational view showing a dynamic lighted ornamental display, of which a part is shown as a cross section.

As shown in FIG. 32, the dynamic lighted display 240 may be composed of a spherical or circular container 77A having a light permeable wall 77Aa having an air space 78A there-within, stress luminescent elements 15 and/or 16 movably disposed in the air space 78A and a blower 82, in which the container 77A is supported on a base 81A

It is noted that the light emitting elements 15 and/or 16 may be replaced with the light emitting elements 30 (30A, 30B, 30C and 30D) (see FIG. 4A, FIG. 4A, FIG. 4B, FIG. 5A and FIG. 5B).

The blower 82 is connected to an air supply pipe 83 which extends to an air ejecting hole and the air ejecting hole is positioned in the air space 78 through the wall 77Aa, in which the air ejecting hole with a directional angle supplies air into the air space 78 so that an air flow makes a directional rotating movement 80A within the wall 77Aa.

The container 77A has an air exhausting hole (not shown in FIG. 32) in the wall 77Aa.

The stress luminescent elements 15 and/or 16 are described above referring to FIG. 15 and FIG. 18.

It is noted that the blower 82 is acting as a mechanical energy generator or an air (gas) flow supply device to give the stress luminescent elements 15 and/or 16 which include stress luminescent material.

When the air is supplied to a fixed direction along an inner surface the wall 77a from the air ejecting hole, the air is subjected to make a rotating movement 80 repeatedly and the stress luminescent elements 15 and/or 16 move to circulate corresponding to the rotating movement 80 of the air to the fixed direction.

The stress luminescent elements 15 and/or 16 receive a mechanical energy due to collision, friction and/or impacting during the rotating movement 80 and they emit visible light.

Twenty Seventh Embodiment

A twenty seventh embodiment is other dynamic lighted display using light emitting elements, which is a modification of the twenty fifth embodiment referring to FIG. 31.

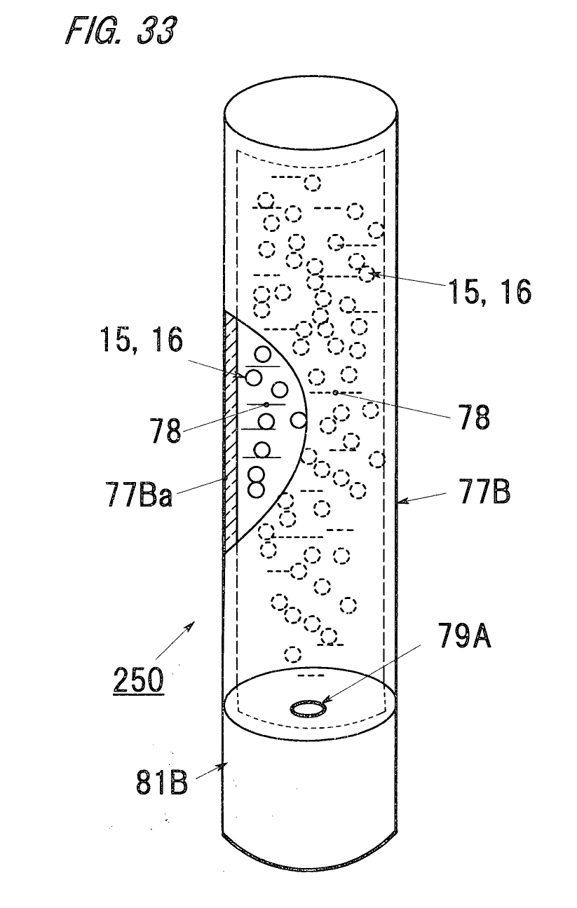

FIG. 33 is a schematic perspective view showing a dynamic lighted display, of which a part is shown as a cross section.

As shown in FIG. 33, the dynamic lighted display 250 may be composed of a cylindrical container 77B supported on a base 81B, a light permeable liquid 78 within the container 77B and stress luminescent elements 15 and/or 16 movably disposed in the liquid 78 and a vibrator 79A.

It is noted that the light emitting elements 15 and/or 16 may be replaced with the light emitting elements 30 (30A, 30B, 30C and 30D) (see FIG. 4A, FIG. 4A, FIG. 4B, FIG. 5A and FIG. 5B).

The cylindrical container 77B may be composed of a light permeable cylindrical wall 77Ba, a circular bottom wall and a circular top wall so as to form a liquid-tight structure having a hollow cylindrical space within the wall 77Ba.

The vibrator 79A preferably a piezo-electric vibrator may be disposed on the bottom wall of the cylindrical wall 77Ba or at a top end of the base 81B, so that the vibrator 79A gives any kinds of vibration such as mechanical, ultrasonic and acoustic vibrations to the light permeable liquid 78 filled in the space within the hollow cylindrical wall 77Ba.

The light emitting elements 15 and 16 preferably have a specific gravity similar to the specific gravity of the liquid 78, so that the light emitting elements 15 float at predetermined depth in the liquid 78 when the vibrator 79A stops to operate.

When the vibrator 79A is driven electrically, the liquid 78 and the stress light emitting elements 15 and 16 are stirred and scattered by the vibration generated from the vibrator 79A within the wall 77Ba, so that the stress light emitting elements 15 and 16 repeat an up and down movements.

These up and down movements are enhanced by using the piezo-electric vibrator 79A generating an ultrasonic vibration, since an ultrasonic wave produces and destructs many air bubbles i.e. air pockets in the liquid 78 by an effect of a cavitation and thereby the stress light emitting elements 15 as well as the liquid 78 performs intensely a random movement and the stress light emitting elements 15 can emit visible flashing light with brighter luminance due to the random movement.

Twenty Eighth Embodiment

The twenty eighth embodiment is an application of the light emitting elements or devices to a display device for use in advertisements and public addresses.

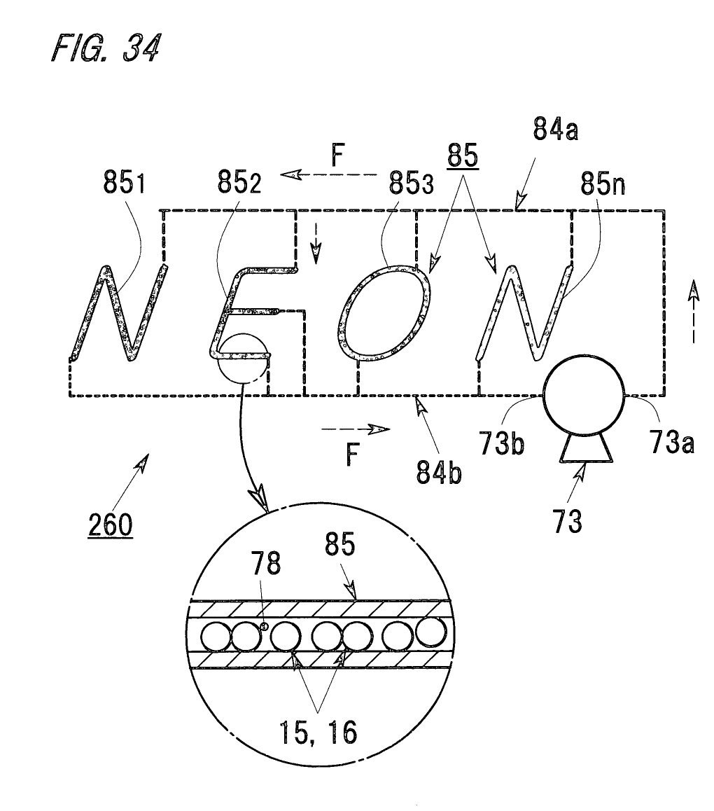

The twenty eighth embodiment is explained with reference to FIG. 34.

FIG. 34 is a schematic explanatory view, in which a part is shown as an enlarged cross section, showing a display device for use in advertisements and public addresses,

As shown in FIG. 34, a display device 260 may be composed of at least one light permeable pattern-like pipe 85, a fluid supplying pipe 84a, a fluid collecting pipe 84b and a fluid circulating pump 73.

The at least one light permeable pattern-like pipe (tube or hose) 85 may be composed of any patterned configuration such as alphabetic characters, numerals and graphic patterns.

The circulating pump 73 is connected to one end of the fluid supplying pipe 84a at that fluid supplying-hole 73a and it is connected to one end of the fluid collecting pipe 84b at that fluid collecting-hole 73b.

Furthermore, the display device 260 is composed of a fluid 78 such as air and/or liquid and a plurality of light emitting elements 15 (see FIG. 15) and/or 16 (see FIG. 18) movably disposed in the fluid 78, in which the fluid 78 and the light emitting elements 15 and/or 16 move to circulate in the pipes 84a and 84b and the pattern-like pipe 85.

It is noted that the light emitting elements 15 and/or 16 may be replaced with the light emitting elements 30 (30A, 30B, 30C and 30D) (see FIG. 4A, FIG. 4A, FIG. 4B, FIG. 5A and FIG. 5B).

The light emitting elements 15 and/or 16, each is smaller than an inner diameter of the pipes 84a and 84b.

The pattern-like pipe (tube or hose) 85, for example, may have a transparent or semi-transparent patterned configuration of the alphabetic characters “NEON” indicated in FIG. 34, in which the pattern-like pipe 85 is composed of a first pattern-like pipe 85-1 indicating “N”, a second pattern-like pipe 85-2 indicating “E”, a third pattern-like pipe 85-3 indicating “O”, and a fourth pattern-like pipe 85-n (“n” is natural number) indicating “N”, in which these characters are arranged laterally in that order.

The fluid supplying pipe 84a is branched to parallel branched pipes so as to connect with each one part of the patterned pipes 85-1, 85-2, 85-3 and 85-n.

The fluid collecting pipe 84b is branched to parallel branched pipes so as to connect with each one part of the patterned pipes 85-1, 85-2, 85-3 and 85-n.

Therefore, the liquid 78 containing the light emitting elements 15 and 16 are flowed in such sequence as the circulating pump 73, the fluid supplying pipe 84a, the patterned pipes 85-1, 85-2, 85-3 or 85-n, the fluid collecting pipes 84b and the circulating pump 73 in that order, and this fluid flow “F” with arrows is indicated in FIG. 34.

When the liquid 78 containing the light emitting elements 15 and 16 are flowed at least in the light permeable patterned pipes 85-1, 85-2, 85-3 and 85-n, the light emitting elements 15 repeatedly strike and collide with adjacent light emitting elements 15 and/or they repeatedly strike and collide with inner walls of the light permeable patterned pipes 85-1, 85-2, 85-3 and 85-n.

Therefore, the light emitting elements 15 receive a mechanical energy due to that striking and collision and the light emitting elements 15 emit visible light so that people can see the predetermined lighted pattern (e.g. “NEON” in FIG. 34) outgoing from the patterned pipes 85-1, 85-2, 85-3 and 85-n.

Twenty Ninth Embodiment

A twenty ninth embodiment is another display device for use in advertisements and public addresses, which a modification of the twenty eighth embodiment with reference to FIG. 34.

Therefore, a duplicated explanation between both embodiments is omitted here as much as possible.

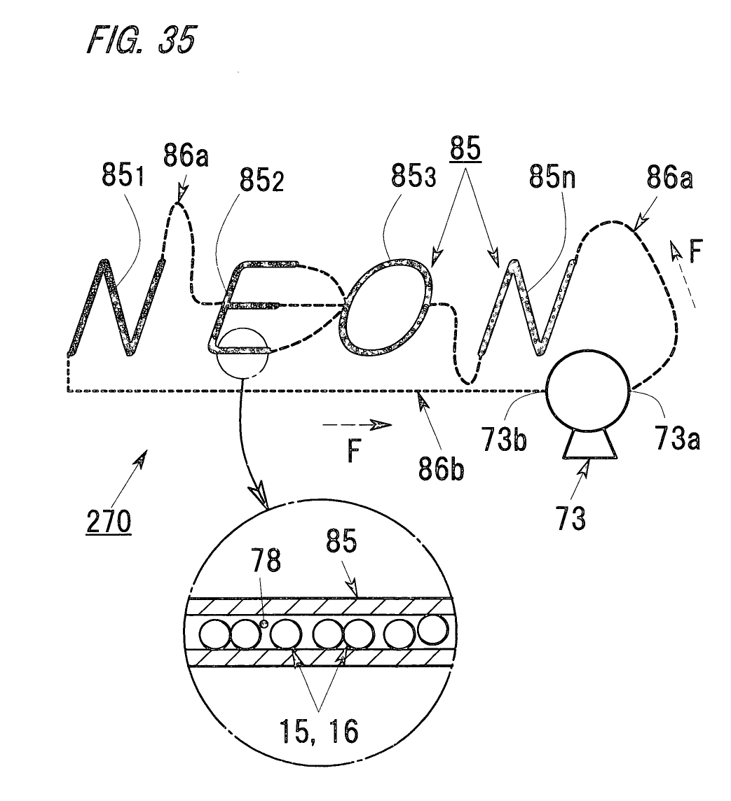

The twenty ninth embodiment is explained with reference to FIG. 35.

FIG. 35 is a schematic explanatory view, in which a part is shown as an enlarged cross section, showing a display device for use in advertisements and public addresses.

As shown in FIG. 35, a display device 270 may be composed of at least one light permeable pattern-like pipe 85, a fluid supplying pipe 86a, a fluid collecting pipe 86b and a fluid circulating pump 73.

The at least one light permeable pattern-like pipe (tube or hose) 85 may be composed of any patterned configuration such as alphabetic characters, numerals and a graphic patterns.

The circulating pump 73 is connected to one end of the fluid supplying pipe 84a at that fluid supplying-hole 73a and it is connected to one end of the fluid collecting pipe 84b at that fluid collecting-hole 73b.

Furthermore, the display device 270 is composed of a fluid 78 such as air and/or liquid and a plurality of light emitting elements 15 (see FIG. 15) and/or 16 (see FIG. 18) movably disposed in the fluid 78, in which the fluid 78 and the light emitting elements 15 and/or 16 move to circulate in the pipes 86a and 86b and the pattern-like pipe 85 (85-1, 85-2, 85-3 and 85-n).

It is noted that the light emitting elements 15 and/or 16 may be replaced with the light emitting elements 30 (30A, 30B, 30C and 30D) (see FIG. 4A, FIG. 4A, FIG. 4B, FIG. 5A and FIG. 5B).

As shown in FIG. 35, unlike the twenty eighth embodiment, the pattern-like pipes 85-1, 85-2, 8-53 and 85-n in this embodiment are connected with the fluid supplying pipe 86a and the fluid collecting pipe 86b substantially in series.

Therefore, the liquid 78 containing the light emitting elements 15 and 16 are flowed based on a fluid flow “F” with arrows as indicated in FIG. 35, in which the pattern-like pipes 85-1, 85-2, 8-53 and 85-n and the fluid supplying pipes 86a are connected together in series connection.

Thirty Embodiment

A thirty embodiment of the present invention is a light emitting sandglass (i.e. sandglass-like light emitting device) using the light emitting elements described hereinbefore.

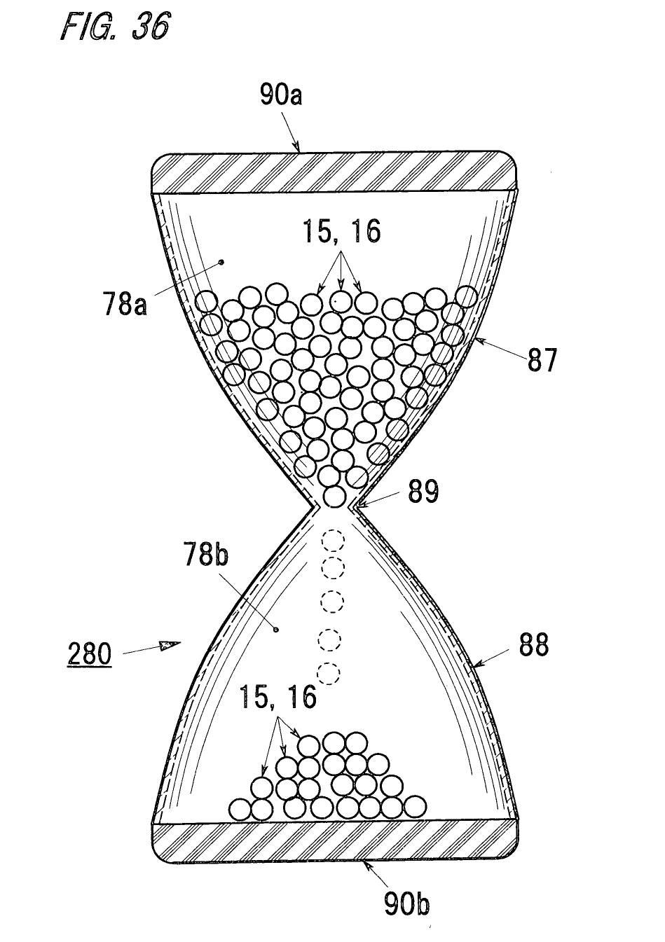

The thirty embodiment is explained with reference to FIG. 36.

FIG. 36 is a schematic elevational view of a light emitting sandglass.

As shown in FIG. 36, a light emitting sandglass 280 may be composed of a transparent first container 87, a transparent second container 88 and a narrow hollow connecting portion 89 communicating with the first container 87 and the second container 88, in which a plurality of small light emitting members 15 and 16 are movably accommodated in at least one of the containers 87 and 88.

It is noted that the light emitting elements 15 and/or 16 may be replaced with the light emitting elements 30 (30A, 30B, 30C and 30D) (see FIG. 4A, FIG. 4A, FIG. 4B, FIG. 5A and FIG. 5B).

The light emitting sandglass 280 may have the same structure as known sandglass except for the light emitting members 15 and 16 (and/or 30), in which the known sandglass uses sands or sand-like members in stead of the light emitting members 15 and 16 which contain stress luminescent material.

The containers 87 and 88 and the narrow hollow connecting portion 89 are made of a transparent glass or a transparent resin such as polycarbonate resin and acrylic resin e.g. PMMA.

The light emitting sandglass 280 may have a base or cover 90a and 90b on a top and a bottom thereof.

A handling method of the light emitting sandglass 280 is the same as that of the conventional sandglass.

At first, the light emitting sandglass 280 is put on a horizontal plane e.g. on a desk in such a manner that all the light emitting elements 15 and 16 are arranged in a first space 78a of the upper first container 87.

With gravity, the light emitting elements 15 and 16 (and/or 30) within the first space 78a fall to a second space 78b of the lower second container 88 little by little through the connecting portion 89 and all the light emitting elements 15 and 16 move to the lower second container 88 after predetermined time.

When the light emitting elements 15/16 (and/or 30) drop gradually from the first space 78a of the first container 87 to the second space 78b of the second container 88 through the connecting portion 89, some light emitting elements collide and rub with other light emitting elements one another and also they collide and rub with an inner wall of the first container 87, so that the light emitting elements 15 and/or 16 receive a mechanical energy such as impact force and friction force.

Furthermore, when the light emitting elements 15/16 (and/or 30) collide with the bottom of the second container 88 or with the light emitting elements 15/16 (and/or 30) accumulated on the bottom, the light emitting elements 15/16 (and/or 30) receives a mechanical energy e.g. an impact or friction force, since there is a fall that is a distance of a level between the connecting portion 89 and the bottom of the second container 88.

Any vibrator (not in FIG. 36) is optionally provided in/on the sandglass 280 to enhance a brightness of luminance.

During dropping of the light emitting elements 15/16/30, the light emitting elements 15/16/30 receiving the mechanical energy emit visible flashing light and exit from the transparent containers 87/88.

Therefore, the light emitting sandglass 280 exhibits an ornamental effect as well as use of conventional timer.

Thirty First Embodiment

A thirty first embodiment of the present invention is a modification of the fourth embodiment described hereinbefore with reference to FIG. 9 and FIG. 10.

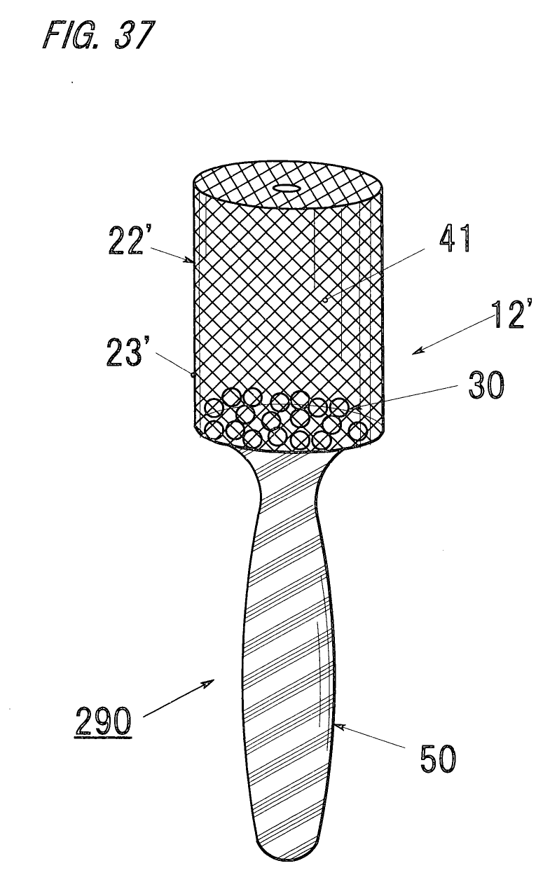

A thirty first embodiment is explained with reference to FIG. 37, in which the explanation duplicated with the fourth embodiment is omitted here as much as possible.

FIG. 37 is a schematic perspective view of a stress lighting device.

As shown in FIG. 37, a stress light emitting device 290 may be composed of a long member 50 acting as a grip and a stress luminescent device 12′ fixed to one end of the long member 50.

A stress light emitting device 12 is composed of a cylindrical mesh-like container 22′ having a space acting as a room 41 surrounded by the mesh-like member 22″ and a plurality of stress light-emitting member 30 movably accommodated in the room 41.

The stress light-emitting member 30 is described in detail referring to FIG. 4A, FIG. 4B, FIG. 5A and FIG. 5B, therefore the description of which is omitted here.

The mesh-like member 22′ may be composed of a cylindrical mesh 23′ having many openings, in which each size of the openings is smaller than each size of the stress light emitting members 30 so that the stress light emitting members do not exit from the openings of the mesh 23′. The mesh-like member 22′ has a light permeable or semi-transparent characteristic since the mesh 23′ has the openings to allow light to pass therethrough.

The mesh-like member 22′ may contain stress luminescent material disposed on/in the mesh 23′.

The mesh-like member 22′ may be replaced with a hollow cylindrical member having a plurality of through-holes, of which each through-hole is smaller than each size of the stress light emitting members 30.

Thirty Second Embodiment

A thirty second embodiment of the present invention is a modification of the ninth embodiment described hereinbefore with reference to FIG. 15.

A thirty second embodiment is explained with reference to FIG. 15, in which the explanation duplicated with the ninth embodiment is omitted here as much as possible.

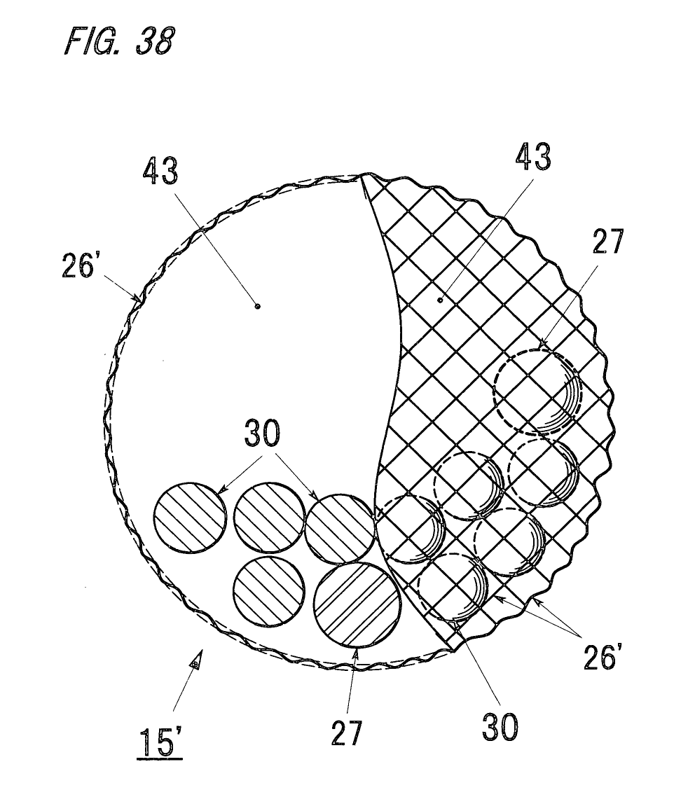

FIG. 38 is a schematic perspective view of a stress lighting device.

As shown in FIG. 38, a stress light emitting device 15′ may be composed of a spherical mesh-like member 26′ having a space acting as a room 43 surrounded by the mesh-like member 26′ and a plurality of stress light-emitting members 30 movably accommodated in the room 43.

The stress light-emitting members 30 are described in detail referring to FIG. 4A, FIG. 4B, FIG. 5A and FIG. 5B, therefore the description of which is omitted here.

The mesh-like member 26′ may have many openings, in which each size of the openings is smaller than each size of the stress light emitting members 30 so that the stress light emitting members 30 do not exit from the openings of the mesh 26′.

The mesh-like member 26′ has a light permeable or semi-transparent characteristic since the mesh 26′ has the openings to allow light to pass therethrough.

The mesh-like member 26′ may be replaced with a hollow spherical member having a plurality of through-holes, of which each through-hole is smaller than each size of the stress light emitting members 30.

At least one agitating member (or weight) 27 may optionally accommodated within the mesh-like member 26′, each weight of which is heavier than that of the stress light emitting members 30.

The mesh-like member 26′ may contain stress luminescent material disposed on/in the mesh.

Thirty Third Embodiment

The thirty third embodiment of the present invention is a modification of the seventh embodiment explained with reference to FIG. 13.

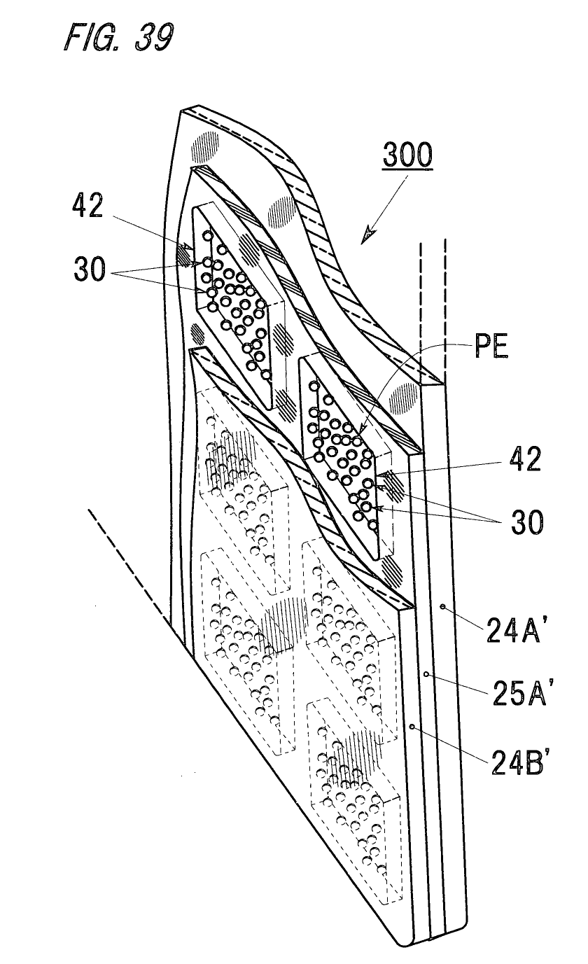

The thirty third embodiment of the present invention is explained with reference to FIG. 39.

FIG. 39 is a schematic perspective view showing a stress light emitting device of the thirty third embodiment, a part of which is shown as a cross section.

As shown in FIG. 39, a light emitting device 300 may be composed of a first sheet 24A′, a second sheet 24B′ and a spacer sheet 25A′ with a plurality of openings (spaces or gaps) 42, in which the spacer sheets 25A′ and 24B′ are sandwiched between the first sheet 24A′ and the second sheet 24B′.

Further, one or more particle-like light-emitting members 30 are inserted in each of the spaces (or gaps) 42 and the light-emitting members 30 can move freely in each of the spaces 42.

The particle-like light-emitting members 30 contain a stress luminescent material disposed thereon/therein.

The substantially rectangular light emitting device 300 shown in FIG. 39 may be composed of a plurality of stress luminescent portions or stress luminescent distributed in X-Y matrix manner to form a substantially flat light emitting sheet.

One or both of the sheets 24A and 24B are made of light permeable polymer material such as Poly methyl methacrylate (PMMA), Polycarbonate (PC), Polyethylene terephthalate (PET), Poly-vinyl chloride and Poly amid.

The substantially rectangular light emitting device 300 shown in FIG. 39 may be composed of a plurality of stress luminescent portions or areas distributed in X-Y matrix manner to form a substantially flat light emitting sheet.

The substantially rectangular light emitting device 300 shown in FIG. 39 may be applied to a flat image display device by combining with an electromechanical transducer (not shown in FIG. 39) such as a piezoelectric film to generate a mechanical vibration.

Such flat image display device may be composed of the flat light emitting sheet 300 shown in FIG. 39 and a plurality of piezoelectric sheets, in which the flat light emitting sheet 300 has a plurality of picture elements “PE” (i.e. pixels) corresponding to the stress luminescent portions or areas distributed in X-Y matrix array and each of the piezoelectric sheets disposed on the flat light emitting sheet 300 to make a vibrating relation to each of the picture elements “PE”,

When the piezoelectric films are selectively driven in accordance with a desired display image and the selected picture elements “PE” receive vibration to emit visible light therefrom.

The flat light emitting sheet 300 shown in FIG. 39 and the piezoelectric sheets may be configured into one sheet-like unit to form the flat image display device, preferably having flexibility capable of bending to form a curvature.

Thirty Fourth Embodiment

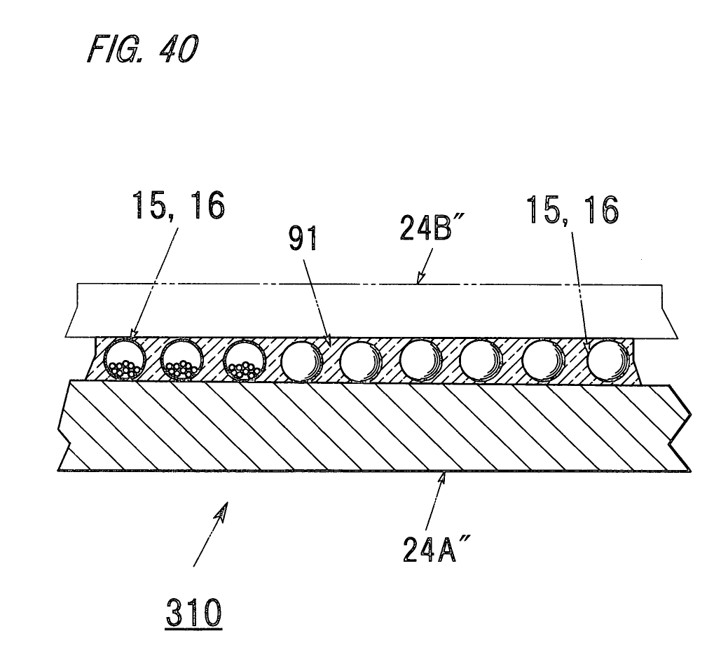

A thirty fourth embodiment is explained with reference to FIG. 40.

FIG. 40 is a schematic partial cross sectional view showing a light emitting device of the thirty fourth embodiment.

As shown in FIG. 40, a light emitting device 310 may be composed of a base sheet (or plate) 24A″ and a light emitting layer formed on the base sheet 24A″, in which the light emitting layer has a light permeable polymer binder 91 and a plurality of stress luminescent capsules 15/16 contained in the polymer binder 91.

The light emitting device 310 may be further composed of additional cover sheet 24B″ to cover the light emitting layer 91 and 15/16 to form an unitary member, in which the light emitting layer 91 and 15/16 is sandwiched with the base sheet 24A″ and the cover sheet 24B″.

One or both of the base sheet 24A″ and the cover sheet 24B″ are made of light permeable material.

As the stress luminescent capsules 15 and/or 16, the capsule-like light emitting device 15 shown in FIG. 15 and/or the duplex capsule-like light emitting device 16 shown in FIG. 18 are preferably used. Optionally, a light permeable liquid may be contained within the capsule wall together with the stress luminescent particles.

For example, similarly to the size of known hard gelatin capsule of drugs, each of the stress luminescent capsules 15/16 may have an outer capsule diameter of about 8 mm-2 mm, in which the stress luminescent particles movably enclosed within the capsule 15/16 may have an outer diameter of about 0.8 mm-0.2 mm.

For example, similarly to the size of known granule of drugs, each of the stress luminescent capsules 15/16 may have an outer capsule diameter of about 2 mm-0.2 mm, in which the stress luminescent particles movably enclosed within the capsule 15/16 may have an outer diameter of about 1/10- 1/100 of the outer capsule diameter.

For example, similarly to the size of known micro-capsule, each of the stress luminescent capsules 15/16 may have an outer capsule diameter of about 500 micron-5 micron, in which the stress luminescent particles movably enclosed within the capsule 15/16 may have an outer diameter of about 1/10- 1/100 of the outer capsule diameter.

The light emitting device 310, for example, may be applied to the flat light emitting sheets and the flat image display devices described above in the thirty third embodiment.

Another application of the flat light emitting sheets 310 is another type of image display device using a scanning head having piezoelectric elements to generate any vibrations such as mechanical, ultrasonic and acoustic vibrations, in which the scanning head scans a surface of the flat light emitting sheets 310 so that desired images can be displayed on the sheets 310.

Thirty Fifth Embodiment

A thirty fifth embodiment of the present invention is a modification of the twenty third embodiment described hereinbefore referring to FIG. 40.

The explanation duplicated with the twenty third embodiment is omitted here as much as possible.

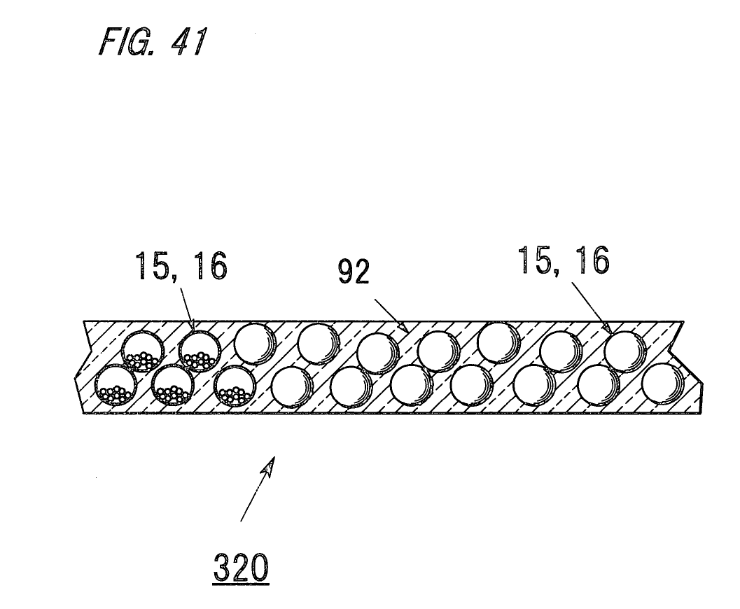

A thirty fourth embodiment is explained with reference to FIG. 41 which is a schematic partial cross sectional view showing a light emitting device of the thirty sixth embodiment.

As shown in FIG. 41, a sheet-like light emitting device 320 may be composed of a light permeable self-supporting sheet 92 and a plurality of stress luminescent members 15/16 disposed in the self-supporting sheet 92, in which the stress luminescent members 15/16 are preferably preliminarily dispersed in a material of the self-supporting sheet 92.

A material of the transparent self-supporting sheet 92 may be selected from thermoplastic polymer, thermosetting polymer, photo-setting polymer, elastomer including thermoplastic elastomer, and synthetic rubber.

If a flexible elastic material is used as the self-supporting sheet 92, the sheet-like light emitting device 320 becomes bendable, therefore even a curved or foldable stress light emitting sheet can be produced. The present invention is not limited to the above-mentioned various embodiments, and any combinations are possible by use of the components or parts in the various embodiments.

Although illustrative embodiments of the present invention have been described referring to the accompanying drawings, it is to be understood that the present invention is not limited to those embodiments and that various changes, modifications or equivalents may be made in the present invention by those skilled in the art without departing from the spirit or the scope of the present invention and the appended claims.

What is claimed is:

1. A light emitting device using a stress luminescent material, comprising:
a container;
at least one stress luminescent member movably disposed within the container;
wherein the at least one stress luminescent member contains a stress luminescent material disposed therein/thereon; and
wherein the stress luminescent material emits light when a mechanical energy is applied thereto.

2. The light emitting device according to claim 1, wherein the container is selected from a capsule, an envelope, a shell, a package, a can and a bottle.

3. The light emitting device according to claim 1, wherein the container comprises a light permeable member partially or entirely disposed in the container.

4. The light emitting device according to claim 1, wherein the container comprises a light shielding member partially or entirely disposed in the container.

5. The light emitting device according to claim 1, wherein the container comprises a light permeable member or a light shielding member having a plurality of through-holes.

6. The light emitting device according to claim 1, further comprises at least one mechanical energy generator in communication with the container.

7. The light emitting device according to claim 1, further comprises at least one mechanical energy generator in communication with the container, and wherein the mechanical energy generator is selected from a vibrator, a gas supply device, a liquid supply device and an air bubble generator.

8. The light emitting device according to claim 1, wherein the light emitting is used in the device selected from a lighting device, an emergency light, an ornament, an accessory, a toy, a playing article, a card, a dynamic or image display, a balloon, a timer and an mechanical energy sensor.

9. The light emitting device according to claim 1, further comprises at least one mechanical energy generator in communication with the container, and wherein the mechanical energy generator is an air bubble generator to generate air bubbles or air pockets in a liquid.

10. The light emitting device according to claim 1, further comprises at least one weight fixedly or movably disposed in/or the container.

11. A light emitting device using a stress luminescent material, comprising:
a container having a stress luminescent material partially or entirely disposed therein/thereon;
at least one member movably disposed within the container; and
wherein the stress luminescent material emits light when a mechanical energy is applied thereto.

12. The light emitting device according to claim 10, wherein the container is selected from a capsule, an envelope, a shell, a package, a can and a bottle.

13. The light emitting device according to claim 10, wherein the container comprises a light permeable member partially or entirely disposed in the container.

14. The light emitting device according to claim 10, wherein the container comprises a light shielding member partially or entirely disposed in the container.

15. The light emitting device according to claim 10, wherein the container comprises a light permeable member or a light shielding member having a plurality of through-holes.

16. The light emitting device according to claim 10, further comprises at least one mechanical energy generator in communication with the container.

17. The light emitting device according to claim 10, further comprises at least one mechanical energy generator in communication with the container, and wherein the mechanical energy generator is selected from a vibrator, a gas supply device, a liquid supply device and an air bubble generator.

18. The light emitting device according to claim 10, wherein the light emitting is used in the device selected from a lighting device, an emergency light, an ornament, an accessory, a toy, a playing article, a card, a dynamic or image display, a balloon, a timer and an mechanical energy sensor.

19. The light emitting device according to claim 10, further comprises at least one mechanical energy generator in communication with the container, and wherein the mechanical energy generator is an air bubble generator to generate air bubbles or air pockets in a liquid.

20. The light emitting device according to claim 10, further comprises at least one weight fixedly or movably disposed in/or the container.
